(19) United States
(12) Patent Application Publication
(10) Pub. No.: US 2010/0050132 A1
(43) Pub. Date: Feb. 25, 2010

(54) System and GUI for specifying composite predicates and dynamic systems

(76) Inventor: Daniel Shia, San Francisco, CA (US)

Correspondence Address: Dan Shia, 1050 N. Point St. #1402, San Francisco, CA, 94109, US

(21) Appl. No.: 12/207,908

(22) Filed: Sep. 10, 2008

Related U.S. Application Data
(60) Provisional application No. 60/993,258, filed on Sep. 11, 2007.

(51) Int. Cl. G06F 3/048

(52) U.S. Cl. 715/854

(57) ABSTRACT

System for specifying the behavior of a composite predicate and a composite dynamic system, and procedures about their operations are provided in the present invention. While a composite predicate is provided to check for a complex condition when a decision is made in a computing system, a composite dynamic system is provided for specifying the behavior of the entire computing system. In addition, a graphical language is provided for showing composite predicates and dynamic systems in graphical diagrams. Some existing graphical languages, such as BPMN and UML Activity Diagrams, are extended with similar capabilities.

### PRIORITY CLAIM/RELATED CASE

This application claims priority under 35 U.S.C. 119(e) to U.S. Provisional Patent Application Ser. No. 60/993,258, filed on Sep. 11, 2007 and entitled “SYSTEM AND GUI FOR SPECIFYING COMPOSITE PREDICATES AND DYNAMIC SYSTEMS”, which is incorporated herein by reference in its entirety for all purposes.

### FIELD OF THE INVENTION

The present invention relates to the design of graphical notation or language for describing predicates, boolean expressions, conditional expressions, flow controls, activities, business processes, and system behaviors and their implementations in software tools.

### BACKGROUND OF THE INVENTION

Due to the sequential nature of a text based computer language, a complex behavior with lots of parallel activities, such as a business process, cannot be easily described in a textual language. For half an century, flowcharts have been used to overcome this weakness of a textual language. However, a flowchart has its own limitations. In recent years, many new computer graphical languages, such as Business Process Modeling Notation (BPMN), UML Activity Diagrams, and Dynamic Systems Chart (DSC), are designed to overcome some of those limitations.

Although there are lots of improvement over the flowchart, these new graphical languages share one common weakness with the flowchart, that is the description of a complex decision or condition is still based on a textual expression.

In a flowchart, a decision point is typically represented by a diamond. Inside of the diamond, a boolean expression is described in text. A decision point may have two or more outgoing arrows and each arrow leads to one next step. For example, one diamond may have two arrows. The boolean expression inside of the diamond may be specified as “X and Y” and one arrow may be tagged by “True” and the other may be tagged by “False”. If both X and Y are true, the arrow with “True” will continue. Otherwise, the other arrow with “False” will continue.

In BPMN, many forms of Gateways are used to represent a decision point. A ConditionExpression attribute can be defined for a Gateway or its outgoing arrows (called “sequence flow” in BPMN). A ConditionExpression attribute is typically specified as a text based expression as defined in XML Path Language (XPath).

In a UML Activity Diagram, a decision node may have multiple outgoing edges, and each of these edges has a guard condition specifying under which condition the edge should be selected. The join node in the UML Activity Diagram may have a join specification that describes under which condition the flow should continue along its single output edge. In either case, the condition is specified by a text based boolean expression.

DSC is a graphical language for describing behavior in terms of Dynamic Systems (DS's). In DSC, decisions need to be made in two places. One is the Transition-condition associated with a Transition-arrow, and the other is the Exit-condition associated with an Exit-point. Both Transition-condition and Exit-condition can be specified as boolean expressions.

When describing a simple condition, a text based boolean expression, such as “X and Y”, does the job well. However, when describing a complex condition, which requires using logical “AND” or “OR” operators to combine multiple simple expressions, a text based boolean expression is not entirely satisfactory for several reasons.

First, the behavior of a text based, complex boolean expression may be counter-intuitive, since the evaluation sequence relies on some implicit precedence rules. For example, “A∥B && C∥D && E” is a C/C++/Java expression where “∥” represents a logical OR and “&&” represents a logical AND. There is an implicit precedence rule in these programming languages that “&&” has a higher precedence than “∥”. Therefore, “A∥B && C∥D && E” really means “A∥(B && C)∥(D && E)” instead of “((A∥B) && C∥D) && E” as some people may expect.

Second, a text based boolean expression can only operate on two operands at a time, hence, cannot operate on multiple operands simultaneously. If many operands must be checked at the same time, duplicated logical operators, such as AND and OR, need to be specified. For example, if we want to describe a condition that all of A, B, C, D, and E must to true, then the expression “A && B && C && D && E” is specified. Ideally, these repeated logical operators should not be required. In addition, since only two operands are evaluated at one time, some undesirable side effects may be produced unintentionally by repeatedly applying these operators.

Third, when there are multiple operands, a text based boolean expression typically cannot describe if any two of those operands are true, then the condition is considered to be satisfactory. Nor can it describe if at least or at most two of them are true, then the condition is met. What if a decision is based on whether there are a number of those operands that are true? A boolean expression simply does not have a mechanism to deal with these situations. However, these are possible real world conditions that may need to be described in a computing system.

Forth, a boolean expression is typically evaluated to only two different results, namely yes (true) or no (false). It is not suitable for specifying a decision where multiple choices need to be selected simultaneously. In order to specify multiple choices of a decision, one would have to specify a boolean expression for each of these multiple choices so that one of these choices is selected when its associated boolean expression is tested to be true. With BPMN, this can be done by specifying a boolean expression for each outgoing sequence flow of a Gateway. If the condition is relatively simple, this approach is OK. However, for relatively complex conditions, writing multiple long boolean expressions would be tedious. For example, the following is a partial list of boolean expressions that may need to be specified: 1) “if age is lower than 5, religion is X, and nationality is A”, 2) “if age is lower than 5, religion is Y, and nationality is A”, 3) “if age is over 20, religion is X, and nationality is B”, 4) “if age is over 20, religion is X, and nationality is C”, etc. In the worst scenario, there can be N*M*O of boolean expressions to specify, where N is the number of age categories, M is the number of religions, and O is the number of countries. Worse yet, age, religion and country may be repeatedly tested as many as N*M*O times in order to find one condition that is true. A more structured specification of complex conditions would be desirable.

Fifth, the complex decision logic and conditions cannot be shown in graphics like the rest of the behavior specifications. Since the decision logic is a fundamental part of any complex behavior, by keeping the complex decision logic in a text form, full graphical representation of the behavior of a computing system cannot be accomplished.

It would be desirable that complex decisions and conditions can also be described in a graphical notation, which overcomes all above-mentioned deficiencies of a text based boolean expression. The present invention provides such a solution.

### BRIEF SUMMARY OF THE INVENTION

This invention describes how a complex decision or condition as part of the behavior of a computer system may be specified by Composite-predicates and the Graphical User Interface (GUI) for showing such Composite-predicates on a display device. In addition, the GUI of Composite-predicates may be generalized so that the entire behavior of a computing system may be described graphically in a consistent fashion.

One purpose of this invention is to specify complex decisions and conditions in an application system by graphical representations to facilitate the understanding of how decisions are made in the system.

Another purpose is to improve how complex decisions or conditions, which may have multiple parameters and multiple results, are specified.

In order to achieve these purposes, system for specifying Composite-predicates, and GUI for representing these complex predicates graphically are provided in the present invention.

This invention uses a Composite-predicate to describe a complex decision or condition. The Composite-predicate has following components: 1) sub-predicates, 2) Transitions, 3) End-points, and 4) Exit-points. The procedure for handling or processing a Composite-predicate is also described.

The present invention also describes how a Composite-predicate may be presented in a diagram using a graphical language, including Dynamic System Chart (DSC), BPMN and UML Activity Diagrams.

The same compositional structure of a Composite-predicate is then generalized into a Composite Dynamic System (Composite-DS) for describing more general behavior of a computing system. A Composite-DS has following components: 1) sub-DS's, 2) Transitions, 3) Begin-points, 4) End-points, and 5) Exit-points. How a Composite-DS may be presented graphically is also described. In addition, the present invention provides ways to extend existing graphical languages, such as BPMN and UML Activity Diagrams, to describe and support the Composite-DS construct.

Finally, several exemplary embodiments are provided to show how the present invention can be used in various ways.

Reference to the remaining portions of the specification, including the drawings and claims, will realize other features and advantages of the present invention. Further features and advantages of the present invention, as well as the structure and operation of various embodiments of the present invention, are described in detail below with respect to accompanying drawings, like reference numbers indicate identical or functionally similar elements.

### BRIEF DESCRIPTION OF THE SEVERAL VIEWS OF THE DRAWING

FIG. 1 is a simplified block diagram showing an example of a distributed computing environment;

FIG. 2 is a simplified block diagram illustrating a computer system that can be used to implement the present invention;

FIG. 3 shows a composite Dynamic System;

FIG. 4 shows a general form of Composite-predicate;

FIG. 5 shows a particular Composite-predicate example;

FIG. 5A shows how to define a parallel sub-predicate in a Sequence;

FIG. 5B shows a concrete example of Composite-predicate;

FIG. 6 shows a Composite-predicate with implicit End-points;

FIG. 7 shows a Composite-predicate with an ν Exit-condition;

FIG. 8 shows a Composite-predicate with an “Exactly-N” Exit-condition;

FIG. 9 shows a Composite-predicate with an ̂ Exit-condition;

FIG. 10 shows a Composite-predicate with an “At-most-N” Exit-condition;

FIG. 11 shows a nested Composite-predicate;

FIG. 12 shows a simplified Composite-predicate with End-points skipped;

FIG. 13 shows a simplified Composite-predicate with “Yes” omitted;

FIG. 14 shows a simplified Composite-predicate with Transition-condition omitted;

FIG. 15 shows one exemplary Composite-predicate with “Yes” as the Transition-condition of the Transition-arrow leading to an End-point;

FIG. 16 shows a simplified Composite-predicate with the “Yes” Transition-condition and the End-point omitted;

FIG. 17 shows a simplified Composite-predicate with default Exit-points omitted;

FIG. 18 is an example with several simple Predicates;

FIG. 19 is a flowchart showing how a Composite-predicate is evaluated;

FIG. 20 shows how a Composite-predicate can be used to describe a complex decision;

FIG. 21 shows another way to use a Composite-predicate to describe a complex decision;

FIG. 22 shows how a Composite-predicate may be used in a decision node in UML;

FIG. 23 shows how a Composite-predicate may be used as an Activity node in UML;

FIG. 24 is an exemplary BPMN diagram with a Complex Gateway defined as a Composite-predicate;

FIG. 25 shows how a Composite-predicate may be used as an Activity in BPMN;

FIG. 26 is left empty;

FIG. 27 shows how the Composite-predicate in FIG. 4 may be emulated in an extended version of BPMN;

FIG. 28 is an exemplary Composite-predicate with only parallel sub-predicates;

FIG. 29 shows the same Composite-predicate in FIG. 28 with an Exit-point of “Yes”;

FIG. 30 shows how the Composite-predicate in FIG. 29 may be emulated in an extended version of BPMN;

FIG. 31 is a Composite-predicate with two Sequences;

FIG. 32 shows how the Composite-predicate in FIG. 31 may be emulated in an extended version of BPMN;

FIG. 33 shows an emulated Composite-predicate may be used as a Gateway in an extended version of BPMN;

FIG. 34 shows an emulated Composite-predicate may be used as an Activity in an extended version of BPMN;

FIG. 35 shows how the Composite-predicate in FIG. 4 may be emulated in an extended version of UML Activity Diagrams;

FIG. 36 shows how the Composite-predicate in FIG. 29 may be emulated in an extended version of UML Activity Diagrams;

FIG. 37 shows how the Composite-predicate in FIG. 31 may be emulated in an extended version of UML Activity Diagrams;

FIG. 38A shows how an emulated Composite-predicate may be used as a decision node in an extended version of UML Activity Diagrams;

FIG. 38B shows how an emulated Composite-predicate may be used as an Activity node in an extended version of UML Activity Diagrams;

FIG. 39 shows how a Composite-predicate may be emulated in a general graphical language;

FIG. 40 shows how the Composite-DS in FIG. 3 may be emulated in an extended version of BPMN;

FIG. 41 shows how the Composite-DS in FIG. 3 may be emulated in an extended version of UML Activity Diagram;

FIG. 42 is a nested Composite-DS example;

FIG. 43 shows how the nested Composite-DS in FIG. 42 may be emulated in an extended version of BPMN;

FIG. 44 shows how the nested Composite-DS in FIG. 42 may be emulated in an extended version of UML;

FIG. 45 shows one example of a Composite-predicate with a subordinate Simple-predicate and an indirect Exit-point;

FIG. 46 shows one example of a Composite-predicate with a subordinate Composite-predicate and an indirect Exit-point;

FIG. 47 shows one example of a Composite-predicate with a subordinate Simple-predicate, a Transition, and an indirect Exit-point;

FIG. 48 shows one example of a Composite-predicate with two subordinate Simple-predicates and an indirect Exit-point;

FIG. 49 shows one example of a Composite-predicate with a subordinate Simple-predicate, a subordinate Composite-predicate and an indirect Exit-point;

FIG. 50 shows one example of a Composite-predicate with a subordinate Simple-predicate, a Transition, and a direct Exit-point;

FIG. 51 shows one example of a Composite-predicate with two subordinate Simple-predicates, a Transition, and a direct Exit-point;

FIG. 52 shows one example of a Composite-predicate with a subordinate Composite-predicate, a Transition, and a direct Exit-point.

### DETAILED DESCRIPTION OF THE INVENTION

The present invention in the form of one or more exemplary embodiments will now be described. In the following description, numerous specific details are set forth in detail to provide a more thorough description of the invention. It will be apparent to one skilled in the art, however, that this invention can be practiced without these specific details. In other instances, well known features have not been described in detail so as not to unnecessarily obscure the invention.

Many computing systems have complex behaviors. This invention uses the Dynamic-System (DS) construct to describe the internal behavior of these computing systems. In order to display the internal behavior of a computing system to human users, some graphical languages are provided in this invention as man-machine interface to facilitate the understanding of the complex behavior being described. A design tool may use one of these graphical languages to allow a user to specify the behavior of a computing system. Another tool may use one of these graphical languages to show the run time behavior of a computing system on a graphical screen.

In order to perform some useful functions, a computing system may need to make complex decisions. The present invention uses a Predicate construct to specify the internal behavior of a decision. The behavior of a Predicate may also be displayed visually for human users using one of the graphical languages provided in this invention.

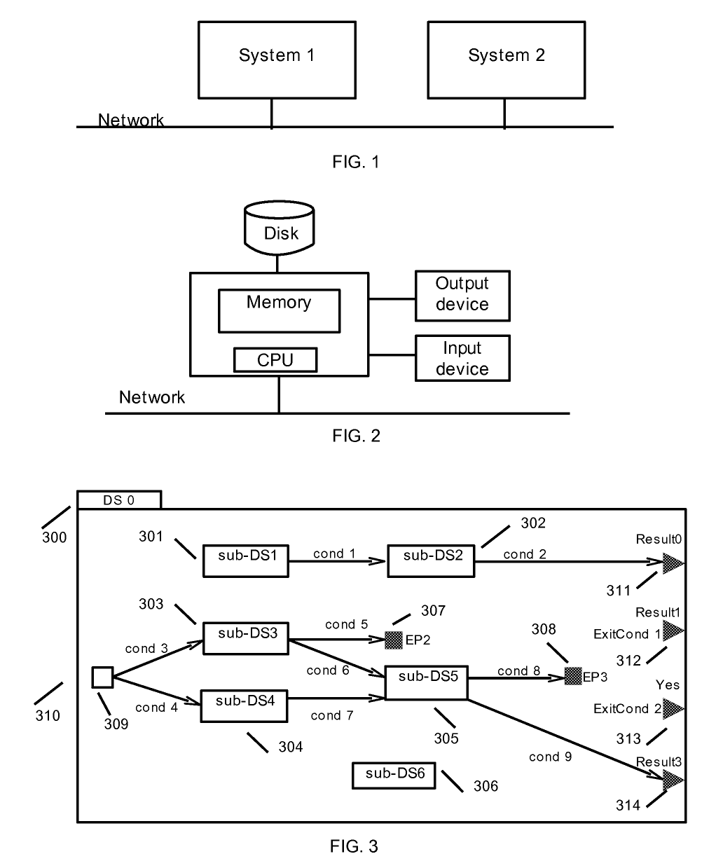

The complex behavior including complex decisions described in this invention may apply to a wide range of software or hardware systems in a real time or distributed environment as shown in FIG. 1.

A distributed environment typically is made up of multiple hardware systems connected by a network. Each hardware system has one or more central processing units (CPU), memory (ROM, RAM, and disks), and input and output devices as in FIG. 2. The behavior of a computing system running on such a hardware system may be displayed on the output device, while user input to manipulate the graphical representation of the system behavior may be collected using the input device.

The hardware system is typically a computer, which may be a Personal Data Assistant, a cell phone, a laptop, a desktop, a workstation, a mainframe, a real time control device, a networked equipment, or any of a variety of other devices providing computing and input/output capabilities.

The technical characteristics of DS and Predicate and their graphical representations are described in following sections.

### Specifying a Complex Behavior in DSC

DSC is a graphical language that describes complex behavior in terms of DS's. Basically, the behavior of every computing system may be described as a DS. A DS has a Result attribute for recording the resulting status of its execution. A DS can be either simple or composite. While a Composite-DS can be divided into subordinate DS's (sub-DS's) at a lower level, a Simple-DS cannot be further divided. Within a Composite-DS, there can be following components: 1) one or more sub-DS's, 2) zero or more Begin-points, 3) zero or more End-points, 4) zero or more Transitions, and 5) zero or more Exit-points. FIG. 3 shows a Composite-DS as a composite box 310 that contains these components. The name of the Composite-DS is shown in a small label box 300 at the top of the composite box. The “DS0” Composite-DS has six sub-DS's. They are “sub-DS1” 301, “sub-DS2” 302, “sub-DS3” 303, “sub-DS4” 304, “subDS5” 305 and “sub-DS6” 306.

A sub-DS in a Composite-DS may be either sequential or parallel. While a parallel sub-DS is detached from others, a sequential sub-DS has at least one Transition linking it to another sequential sub-DS. Each Transition has a Transition-arrow and a Transition-condition. The Transition-arrow is shown as an arrow leading from its source sub-DS to a target sub-DS, while its corresponding Transition-condition is shown as a label next to the arrow. When a source sub-DS completes its execution, the Transition-condition associated with each of its outgoing Transition-arrows is evaluated. If anyone is true, the target sub-DS pointed to by its associated Transition-arrow is selected as the next sub-DS to start. For example, as shown in FIG. 3, “sub-DS3” 303 has two Transition-arrows, one of which leads from it to an End-point 307 (shown as a small solid square) and another leads to “sub-DS5” 305. The Transition-condition associated with the Transition-arrow leading to the end-point 307 is “cond5” and the Transition-condition associated with the Transition-arrow leading to “sub-DS5” is “cond6”.

All these sequential sub-DS's linked together by one or more Transition-arrows form a Sequence in the Composite-DS. For example, “sub-DS1” 301 and “sub-DS2” in FIG. 3 form the first Sequence, while “sub-DS3” 303, “sub-DS4” 304 and “sub-DS5” 305 form the second Sequence in “DS0” 300. To distinguish one Sequence from another, a unique identifier, called Sequence-ID, may be assigned internally to each Sequence in a Composite-DS.

In addition to sequential sub-DS's, a Sequence may also have multiple Begin-points and End-points. Each Begin-point may have multiple outgoing Transitions. It may be shown as an empty square inside of its containing Composite-DS. For example, the Begin-point 309 in FIG. 3 has two Transitions. The Transition-condition of one of them is “cond3” and the other is “cond4”.

Each End-point in a Sequence may have a name or an identifier, and may be shown as a solid square. For example, as shown in FIG. 3, “EP2” 307 is one End-point and “EP3” 308 is another in the second Sequence in “DS0” 300.

When the Composite-DS starts to evaluate, all its Sequences may start simultaneously. Within a Sequence, only one sequential sub-DS may be evaluated at any point in time. The execution of a Sequence starts from one of its initial sub-DS's, which is either the sub-DS that does not have any Transition-arrow pointing to it or a sub-DS that is a target of a Transition-arrow leading from a Begin-point. If there are more than one initial sub-DS in a Sequence, only the one whose incoming Transition-condition is true is chosen to evaluate. For example, when “DS0” 300 in FIG. 3 starts, as the only initial sub-DS in the first Sequence, “sub-DS1” 301 starts to evaluate. In addition, when “DS0” starts, the second Sequence also starts. If “cond3” is true, “sub-DS3” 303 would start to evaluate, whereas if “cond4” is true, “sub-DS4” 304 would start.

Sequential sub-DS's in a Sequence evaluate one at a time until one End-point is reached. When an End-point is reached, the Sequence containing the End-point terminates, and an internal end-value associated with the End-point just reached are recorded. This information may later be examined by Exit-conditions in the containing Composite-DS.

Unlike a sequential sub-DS, a parallel sub-DS in a Composite-DS does not have any Transition attached to it. When a Composite-DS starts, all its parallel sub-DS's may start simultaneously along with all other Sequences. For example, “sub-DS6” 306 in FIG. 3 is a parallel sub-DS, and when “DS0” 300 starts, “sub-DS6” 306 also starts.

From another perspective, a parallel sub-DS can be viewed as a Sequence that has a single sub-DS with a Transition, whose Transition-condition is specified as “Yes”, leading to a direct “Yes” End-point. Therefore, if a parallel sub-DS exits with a positive value, it can be viewed as if its corresponding Sequence ends with a positive end-value. Hence, in this document, a parallel sub-DS may also be treated as a special case of a Sequence hereafter.

A Composite-DS may have multiple Exit-points, and each of them internally has an associated exit-value.

An Exit-point may be direct or indirect. In addition to an associated exit-value, a direct Exit-point may have a name. When a direct Exit-point is reached, the Composite-DS exits and its Result attribute is set to the exit-value associated with the Exit-point just reached. A direct Exit-point may be shown as a solid triangle directly pointed to by a Transition-arrow, while its name is shown next to the solid triangle. For example, “DS0” 300 in FIG. 3 has two direct Exit-points, namely “Result0” 311 and “Result3” 314. The “Result0” Exit-point is pointed to by the Transition-arrow with the “cond2” Transition-condition, while the “Result3” Exit-point is pointed to by the Transition-arrow with the “cond9” Transition-condition. When “sub-DS2” 302 exits, if “cond2” is evaluated to be true, the “Result0” Exit-point 311 is reached. When the “Result0” Exit-point is reached, the “DS0” Composite-DS exits with its Result set to the exit-value associated to the “Result0” Exit-point.

Instead of being pointed to by a Transition-arrow, an indirect Exit-point is shown as a solid triangle detached from any sub-DS. An indirect Exit-point may have a name and an Exit-condition in addition to an associated exit-value. The Exit-condition describes a situation under which the Composite-DS shall exit and its Result shall be set to the exit-value associated with the indirect Exit-point. A user defined indirect Exit-point is shown as a solid triangle with its Exit-condition shown next to it. For example, “DS0” 300 in FIG. 3 has two user defined indirect Exit-points, namely “Result1” 312 and “Yes” 313.

Whenever a Sequence exits, each of these Exit-conditions in the Composite-DS is checked. If any Exit-condition is evaluated with a positive result, the Composite-DS exits, and its Result is set to the exit-value of the corresponding Exit-point. For example, as shown in FIG. 3, when “EP2” or “EP3” is reached or “sub-DS6” 306 has exited, each of “ExitCond1” and “ExitCond2”, is checked. If “ExitCond1” is evaluated with a positive result, “DS0” 300 exits, and its Result is set to the exit-value associated with “Result1” 312. On the other hand, if “ExitCond2” is evaluated with a positive result, “DS0” 300 exits, and its Result is set to the exit-value associated with “Yes” 313. In case none of these Exit-conditions is true, the evaluation of the Composite-DS continues until all Sequences have exited.

In addition to user defined Exit-points, every Composite-DS has a system predefined indirect implicit Exit-point. The name of this implicit Exit-point is “No” and its Exit-condition is “Else”. When all its Sequences have exited and none of user defined Exit-conditions has a positive result, the Composite-DS exits at this implicit Exit-point with its Result set to the exit-value associated with the “No” Exit-point.

To differentiate the “No” Exit-point from other user defined Exit-points, while each of other user defined Exit-points has a positive value, the exit-value associated with the “No” Exit-point has a non-positive value.

### Specifying a Complex Predicate in an Extended DSC

With the basic DSC, a Predicate such as “cond1” or “ExitCond1” in FIG. 3 can only be specified in a text-based expression. By extending the basic DSC with the present invention, a Predicate can also be specified in a graphical notation. An extended version of DSC with predicates specified graphically following the same DSC style is described below in this section.

Basically, the purpose of a Predicate in this invention is to check for a set of conditions when making a decision. For example, a Transition-condition is to make a decision whether its associated Transition-arrow should be followed or not. A Predicate typically examines some data that represent the current condition and evaluates to a Result, whose value is either positive or non-positive. The Result can then be stored in memory, such as cache or a data register, and used to determine which operations are to be performed subsequently. If a Predicate evaluates to a positive value, it means that a desirable condition is met. On the other hand, if a Predicate evaluates to a non-positive value, it means that none of the desirable conditions is met.

A traditional Boolean predicate typically evaluates to one of two possible values, which is either true or false. However, the Predicate in this invention is generalized to support multiple positive result values, while keeping only one non-positive result value. In other words, a Predicate of this invention evaluates to either a non-positive result value or one of many positive result values.

The rationale for supporting multiple positive result values is that in many real world applications, a decision is made either to continue or not to continue the handling or processing of certain application data. If a decision is to continue the processing, there can be many different ways to continue the processing. If a predicate only supports one positive and one non-positive result value, a series of predicates would be required to choose from more than two ways to continue the processing. However, with multiple positive result values, a predicate can decide whether to continue the processing or not, and if the decision is to continue, it can also decide which of the many different ways to proceed using a different value to represent each of the many ways. In general, a predicate supporting multiple positive result values is more efficient and flexible than a predicate that supports only one positive and one non-positive result.

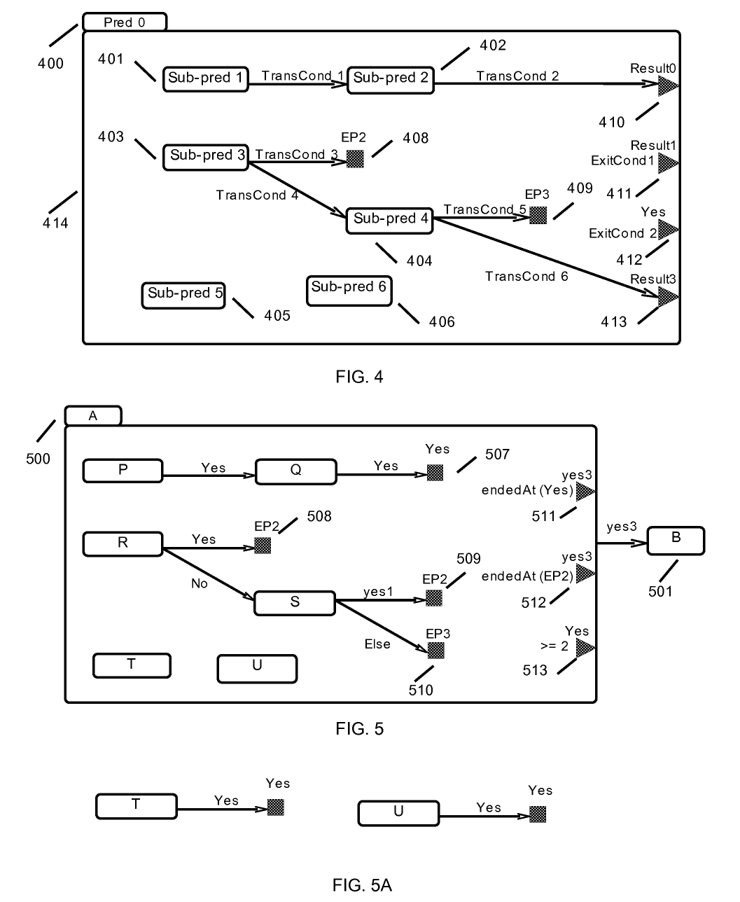

With the present invention, a Predicate is either simple or composite. A Simple-predicate cannot be further divided, whereas a Composite-predicate can be divided into some components. A Composite-predicate has a similar compositional structure to a Composite-DS. In addition to the Result attribute, it has following components: 1) one or more subordinate predicates (sub-predicates), 2) zero or more End-points, 3) zero or more Transitions, and 4) zero or more Exit-points. The only missing component is the Begin-point, which is not needed in a Composite-predicate. FIG. 4 shows a Composite-predicate as a composite box 414 with round corners that contains its components. Its name, “Pred0”, is shown in a small label box 400 at the top of the composite box. The “Pred0” Composite-predicate has six sub-predicates. They are “Sub-pred1” 401, “Sub-pred2” 402, “Sub-pred3” 403, “Sub-pred4” 404, “Sub-pred5” 405, and “Sub-pred6” 406.

These sub-predicates in a Composite-predicate are predicates at a lower level and they can be either sequential or parallel. A sequential sub-predicate has at least one Transition linking it to another. A Transition has a Transition-arrow and a Transition-condition. A Transition-arrow may be shown as an arrow, and its Transition-condition may be shown next to the arrow. For example, “Sub-pred1” 401, “Sub-pred2” 402, “Sub-pred3” 403, and “Sub-pred4” 404 in FIG. 4 are sequential sub-predicates, since each of them has at least one Transition-arrow linking it to others. “Sub-pred1” 401 has one Transition, whose Transition-condition is “TransCond1”, whereas “Sub-pred3” 403 has two Transitions, whose transition-conditions are “TransCond3” and “TransCond4”.

All those sequential sub-predicates linked together by one or more transition-arrows form a Sequence. For example, “Sub-pred1” 401 and “Sub-pred2” 402 in FIG. 4 form the first Sequence, while “Sub-pred3” 403 and “Sub-pred4” 404 form the second Sequence. To distinguish one Sequence from another, a unique identifier, called Sequence-ID, may be assigned internally to each Sequence in a Composite-predicate.

In addition to sequential sub-predicates, a Sequence may also have multiple user defined End-points. Each user defined End-point may have a name and is shown as a solid square. For example, “EP2” 408 and “EP3” 409 in FIG. 4 are user defined End-points in the second Sequence.

When the Composite-predicate starts to evaluate, all its Sequences may start simultaneously. However, within a Sequence, sub-predicates are evaluated one at a time sequentially. The evaluation of a Sequence starts from its initial sub-predicate, which is a sequential sub-predicate that does not have any Transition-arrow pointing to it. For example, “Sub-pred1” in FIG. 4 is the initial sub-predicate in the first Sequence and “Sub-pred3” is the initial sub-predicate in the second Sequence. After each sub-predicate is evaluated, one of its multiple possible Transition-arrows is selected to find the next sub-predicate to evaluate. How to select the next sub-predicates to evaluate is described below.

Each Transition-arrow leads from a source sub-predicate to a target sub-predicate, and it has an associated Transition-condition. The Transition-condition specifies a particular Result value of the source sub-predicate. After a source sub-predicate is evaluated, if its Result value is the same as specified in the Transition-condition, the target of the Transition-arrow is the one to be evaluated next. For example, as shown in FIG. 4, after “Sub-pred3” 403 is evaluated, if “TransCond4” is true, “Sub-pred4” 404 is to be evaluated next, and if “TransCond3” is true, the “EP2” End-point 408 is the next one to be evaluated. How an End-point is evaluated will be described later.

A user defined Transition-condition may specify 1) “No”, 2) “Yes”, 3) any user defined Exit-point name in the source sub-predicate, or 4) “Else”. Each of them is further described below:

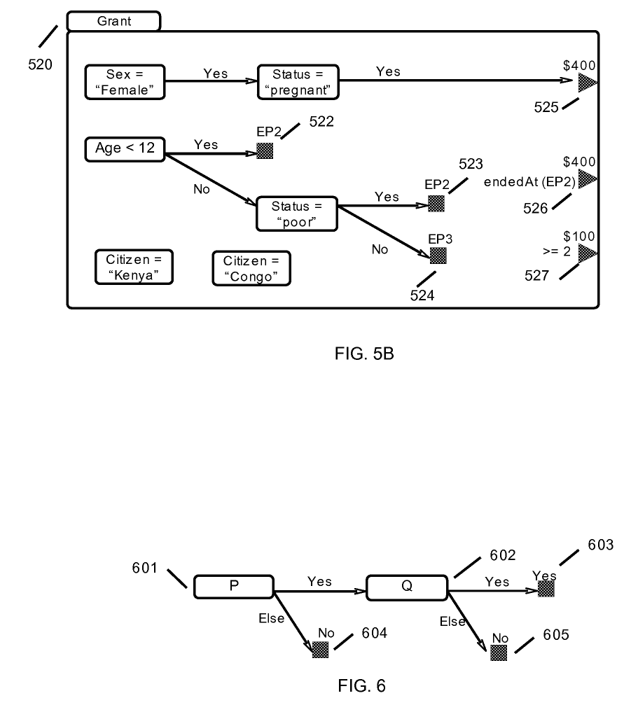

1) The “No” Transition-condition indicates that if the source sub-predicate is evaluated to a non-positive Result, the target of the corresponding Transition-arrow is chosen to be evaluated next. For example, as shown in FIG. 5, after the “R” sub-predicate is evaluated, if its Result value is non-positive, the “S” sub-predicate is to be evaluated next.

2) A Transition-condition of “Yes” indicates that if the source sub-predicate evaluates to any positive value, the target of the corresponding Transition-arrow is chosen to be evaluated next. For example, as shown in FIG. 5, after the “R” sub-predicate is evaluated, if its Result value is positive, the “EP2” End-point 508 is to be evaluated next.

3) A Transition-condition with an Exit-point name indicates that if the source sub-predicate evaluates to the exit-value of that particular Exit-point, the target of the corresponding Transition-arrow is chosen to be evaluated next. For example, as shown in FIG. 5, after the “S” sub-predicate is evaluated, if its Result is the exit-value associated with the “yes1” Exit-point of the “S” sub-predicate, the “EP2” End-point 509 is to be evaluated next.

4) A Transition-condition of “Else” indicates that if all other Transition-conditions of the same source are not met, the target of the target of the corresponding Transition-arrow is chosen to be evaluated next. For example, as shown in FIG. 5, after the “S” sub-predicate is evaluated, if the other Transition-condition of “yes1” is not met, the “EP3” End-point “510 is the next to be evaluated.

Those sequential sub-predicates within a Sequence are evaluated one by one until an End-point is to be evaluated. Once an End-point is reached, the Sequence terminates, and an internal end-value associated with the End-point just reached are recorded so that Exit-conditions can later check on the termination status of each Sequence in the Composite-predicate. An end-point name may be “Yes” (507 in FIG. 5), “No”, or a user defined name. If any of these end-points needs to be differentiated from each other, each of them should have a unique name, such as “EP2” 508 or “EP3” 510 in FIG. 5. However, if some of these end-points do not need to be differentiated, they can share the same name, which can be “Yes”, “No” or a user defined name, with others. For example, two End-points 508 and 509 in FIG. 5 share the same name, “EP2”. End-point 507 has “Yes” as its name, since it does not need to be differentiated with other possible End-points with the same name.

After a sequential sub-predicate is evaluated, if none of its user defined Transition-conditions is true, a predefined implicit End-point is always reached. This behavior is to cover all possible result scenarios that may not be covered by user defined Transition-conditions. The behavior of the implicit End-point can be viewed as if a predefined Transition-arrow with its Transition-condition specified as “Else” leading to a predefined End-point named “No” is added to each source sub-predicate. For example, FIG. 6 shows how sub-predicates named “P” and “Q” in FIG. 5 are extended with these implicit End-points. After the “P” sub-predicate 601 is evaluated, if its Result value is not positive, the implicit End-point 604 is the next to be evaluated, which indicates that the current Sequence has reached the end and no more evaluation is to be performed for the rest of this Sequence. Similar to terminating at a regular End-point, an internal end-value associated with the implicit End-point is recorded for later examination by Exit-conditions in the Composite-predicate. Although the behavior of these predefined “Else” Transition-conditions and “No” End-points are always there, they typically are not shown in a diagram.

To differentiate a user defined end-point from the implicit end-point, the end-value associated with the “Yes” end-point or any user defined end-point may have a positive value, whereas the end-value associated with the implicit end-point may have a non-positive value. An Exit-condition in the composite-predicate may check the end-value of each Sequence that has been evaluated to determine if the composite-predicate should terminate or not.

Unlike a sequential sub-predicate, a parallel sub-predicate does not have any Transition-arrow. For example, “T” and “U” in FIG. 5 are parallel sub-predicates. When a Composite-predicate is evaluated, all its parallel sub-predicates (along with the initial sequential sub-predicate in each Sequence) may be evaluated simultaneously. For example, when the “A” Composite-predicate 500 in FIG. 5 starts, both the “T” sub-predicate and the “U” sub-predicate start to be evaluated.

From another perspective, a parallel sub-predicate can be viewed as a Sequence that has a single sub-predicate with an outgoing Transition, whose Transition-condition is specified as “Yes”, leading to a direct “Yes” End-point. Therefore, if a parallel sub-predicate exits with a positive value, it can be viewed as if its corresponding Sequence ends with a positive end-value. FIG. 5A shows how each of “T” and “U” parallel sub-predicates in FIG. 5 may be defined as a Sequence. Hence, in this document, a parallel sub-predicate may also be treated as a special case of a Sequence hereafter.

A Composite-predicate may have multiple Exit-points, and each of them has an associated exit-value.

An Exit-point may be direct or indirect. In addition to an associated exit-value, a direct Exit-point may have a name. When a direct Exit-point is reached, the Composite-predicate exits and its Result is set to the exit-value associated with the direct Exit-point just reached. A direct Exit-point may be shown as a solid triangle directly pointed to by a Transition-arrow, while its name is shown next to the solid triangle. The name of an Exit-point can be used to identify the Exit-point itself. Since the exit-value of an Exit-point is internal to the implementation of the Exit-point, it does not need to be displayed in the diagram. For example, “Pred0” 400 in FIG. 4 has two direct Exit-points, namely “Result0” 410 and “Result3” 413. The “Result0” Exit-point is pointed to by the Transition-arrow with the “TransCond2” Transition-condition, while the “Result3” Exit-point is pointed to by the Transition-arrow with the “TransCond6” Transition-condition. When “sub-pred2” 402 exits, if “TransCond2” is evaluated to be true, the “Pred0” Composite-predicate exits with its Result set to the exit-value associated with the “Result0” Exit-point.

Instead of being pointed to by a Transition-arrow, an indirect Exit-point may have a name and an Exit-condition in addition to an associated exit-value. The Exit-condition describes a situation under which the Composite-predicate shall exit and its Result shall be set to the exit-value associated with the indirect Exit-point, A user defined indirect Exit-point may be shown as a solid triangle with its Exit-condition shown at the flat side of the triangle and its name shown above or below the triangle. For example, “Pred0” 400 in FIG. 4 has two user defined indirect Exit-points, namely “Result1” 411 and “Yes” 412. The Exit-condition of the “Result1” Exit-point 411 is “ExitCond1”, while the Exit-condition of the “Yes” Exit-point 412 is “ExitCond2”.

Each Exit-point has an internal exit-value associated to it. This exit-value is to be recorded in the Result attribute when a Composite-predicate exits at that particular Exit-point. There is an one-to-one relationship between the Exit-point name and the exit-value. Hence, if exiting from some Exit-points of a Composite-predicate should lead to the same next sequential sub-predicate, these Exit-points should share the same name. For example, as shown in FIG. 5, in the “A” Composite-predicate 500, Exit-point 511 has “yes3” as its name, which is the same as the name of Exit-point 512. In this case, exiting at either of them would set the same Result value for the “A” Composite-predicate, which would lead to the same next sequential sub-predicate, “B” 501. Note that “Yes” is a predefined name that can also be used for any user defined Exit-point. For example, the name of Exit-point 513 in FIG. 5 is “Yes”.

Whenever a Sequence terminates, the Exit-condition of each of these indirect Exit-points in the containing Composite-predicate is checked. For example, as shown in FIG. 5, when any of “Yes” 507, “EP2” 508, “EP3” 509, or “EP3” 510 is reached, or when each of “T” or “U” exits, each of the “endedAt (Yes)” Exit-condition 511, the “endedAt (EP2)” Exit-condition 512 and the “>=2” Exit-condition 513 is checked. If any Exit-condition is true, the Composite-predicate exits with its Result set to the exit-value associated with that Exit-point. For example, if the first Sequence reaches the “Yes” End-point 507 in FIG. 5, the “endedAt (Yes)” Exit-condition of the “yes3” exit-point 511 is true, and the Composite-predicate “A” 500 exits at the “yes3” Exit-point 511 with its Result set to the exit-value associated with the “yes3” Exit-point 511.

The Exit-condition of a user defined Exit-point can be specified as one of the following: 1) “endedAt (anEndPt)”, where “anEndPt” is the name of an End-point, and 2) comparing the number of Sequences that have been evaluated to a positive end-value to a number. Each of them is further described below:

1) An Exit-condition may be specified as “endedAt (anEndPt)”, where “anEndPt” is the name of an End-point. If a Sequence has reached this particular End-point, the Composite-predicate exits with its Result set to the exit-value associated with the corresponding Exit-point. For example, as shown in FIG. 5, if the “EP2” End-point 508 or 509 is reached, the entire “A” Composite-predicate 500 exits with its Result set to the exit-value associated with the “yes3” Exit-point 512.

2) An Exit-condition can specify how many Sequences, including those Sequences that correspond to parallel sub-predicates, should have been evaluated to positive end-values before the Composite-predicate terminates. For example, one Exit-condition may be “>2”, which means that if the number of Sequences that have been evaluated to positive end-values is larger than 2, the Composite-predicate shall exit and its Result is set to the associated exit-value. Followings are some special cases:

An Exit-condition can be specified as “At-least-N”, where ‘N’ is a positive number. If the total number of Sequences that have terminated with positive end-values is larger than or equal to N, the entire Composite-predicate exits with its Result set to the exit-value of the corresponding Exit-point. Note that when a Sequence reaches any user defined End-point, the Sequence is evaluated to a positive end-value, whereas a Sequence reaching the implicit End-point is evaluated to a non-positive end-value. For example, as shown in FIG. 5, Exit-point 513 has its Exit-condition specified as “>=2”, which means “at least 2”. If the “S” sub-predicate exits with a Result value that is not associated with the “yes1” Exit-point defined for “S”, the “EP3” End-point 510 is reached and the second Sequence in “A” 500 is evaluated to a positive end-value. However, since none of Exit-conditions is true, other sub-predicates still need to be evaluated. If the “T” sub-predicate is subsequently evaluated to a positive result, then there are at least 2 positive end-values, and the entire “A” Composite-predicate 500 exits at the “Yes” Exit-point 513 with its Result set to the exit-value associated with the “Yes” Exit-point 513.

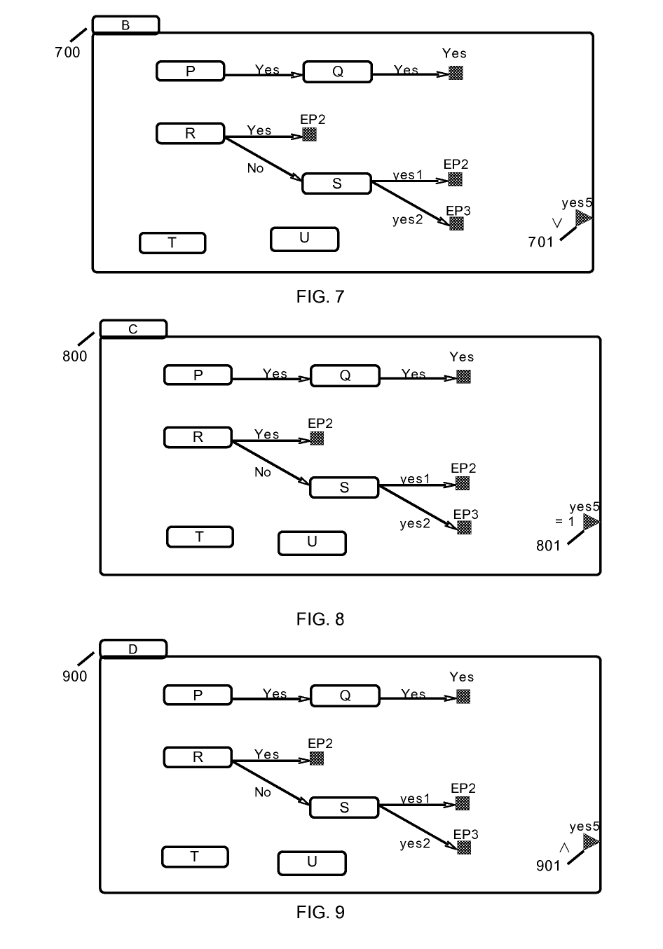

A special case of “At-least-N” is “At-least-1”, which means that at least one of those Sequences in a Composite-predicate needs to have a positive end-value in order for the Composite-predicate to exit at that particular Exit-point. In other words, if any of those Sequences is evaluated with a positive end-value, the Composite-predicate exits. Therefore, conceptually, this special case may be viewed as applying a logical “OR” operation to those Sequences in a Composite-predicate. Either “>=1” or the logical symbol “ν” may be used to represent the “OR” Exit-condition. FIG. 7 shows that the “B” Composite-predicate 700 has the “ν” Exit-condition 701.

An Exit-condition can be specified as “Exactly-N”, where N is a positive number. If the total number of Sequences that have exited with positive end-values is the same as N, the entire Composite-predicate exits with its Result set to the exit-value of the corresponding Exit-point. For example, as shown in FIG. 8, Exit-point 801 has its Exit-condition specified as “=1”, which stands for “exactly 1”. So, if one Sequence has a positive end-value while others have non-positive end-values, the “C” Composite-predicate 800 exits with the exit-value associated with the “yes5” Exit-point as its Result. Note that in order to determine if the total number of positive end-values is exactly the same as specified, all Sequences in a Composite-predicate need to be evaluated.

A special case of “Exactly-N” is that N is the total number of those Sequences in a Composite-predicate. In this case, “Exactly-N” means that each of those Sequences in a Composite-predicate needs to have a positive end-value in order for the Composite-predicate to exit with its Result set to the exit-value of the corresponding Exit-point. In other words, if all those Sequences are evaluated with positive end-values, the Composite-predicate exits at that Exit-point. Therefore, conceptually, this special case may be viewed as applying a logical “AND” operation to those Sequences in a Composite-predicate. Either “=N” or the logical symbol “̂” may be used to represent the “AND” Exit-condition. FIG. 9 shows a Composite-predicate, “D” 900, that has the “̂” Exit-condition 901.

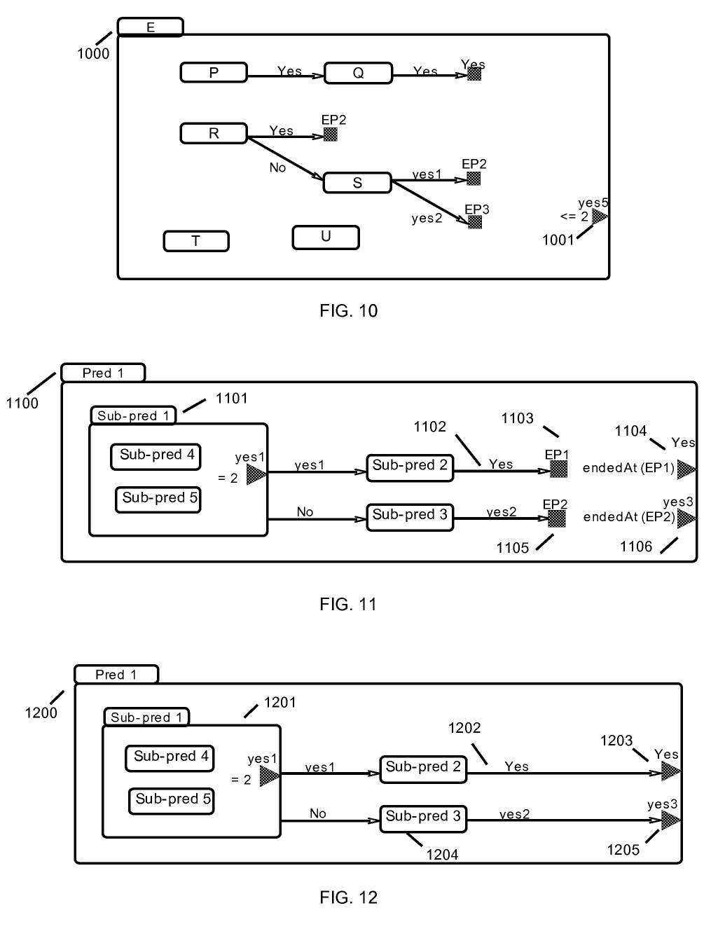

An Exit-condition can be specified as “At-most-N”, where ‘N’ is a positive number. If the total number of Sequences that have exited with positive end-values is smaller than or equal to N, the entire Composite-predicate exits with its Result set to the exit-value of the corresponding Exit-point. For example, as shown in FIG. 10, Exit-point 1001 has its Exit-condition specified as “<=2”, which stands for “At most 2”. So, if one or two Sequences have positive end-values while others have non-positive results, the “E” Composite-predicate 1000 exits with the exit-value associated with the “yes5” Exit-point as its Result.

In addition to user defined Exit-points, a Composite-predicate always have a predefined, indirect implicit Exit-point. The name of this implicit Exit-point is “No” and its Exit-condition is “Else”. When all Sequences have exited and none of user defined Exit-conditions has a positive result, the Composite-predicate exits at this implicit Exit-point with its Result set to the exit-value associated with the “No” Exit-point. For example, if more than three among all Sequences in the “E” Composite-predicate 1000 as shown in FIG. 10 have positive end-values, the Exit-condition, “<=2”, of the only user defined Exit-point 1001 is not true. Hence, the “E” Composite-predicate exits with its Result set to the exit-value of the “No” Exit-point. While each user defined Exit-points has a positive exit-value, the implicit “No” Exit-point has a non-positive exit-value. In addition, unlike other user defined Exit-points, this implicit Exit-point is not shown inside of the Composite-predicate box.

As described earlier, a Composite-predicate may contain multiple sub-predicates. Since each of these sub-predicates can be either simple or composite, a Composite-predicate can be nested. FIG. 11 shows an example nested Predicate, “Pred1” 1100, which contains 3 sub-predicates, namely “Sub-pred1” 1101, “Sub-pred2” and “Sub-pred3”. “Sub-pred1” 1101 is a Composite-predicate that contains 2 sub-predicates, namely “Sub-pred4” and “Sub-pred5”. Each of “Sub-pred4” and “Sub-pred5” again may be a Composite-predicate, hence, forming a hierarchy of nested sub-predicates.

Optionally, the graphical notation of a Composite-predicate can be simplified in following ways: 1) If the name of an End-point is specified in the Exit-condition of one indirect Exit-point, this indirect Exit-point can be converted to a direct Exit-point. This would eliminate the End-point and the Exit-condition from the diagram. For example, as shown in FIG. 11, the Exit-condition of the “endedAt (Yes)” Exit-point 1104 specifies that when the “EP1” End-point is reached by a Sequence, the composite-predicate exits. To convert it into a direct Exit-point, Transition-arrow 1102 can be extended all the way to the “Yes” Exit-point. As shown in FIG. 12, Transition-arrow 1202 links its source sub-predicate, “Sub-pred2”, direct to the “Yes” Exit-point 1203.

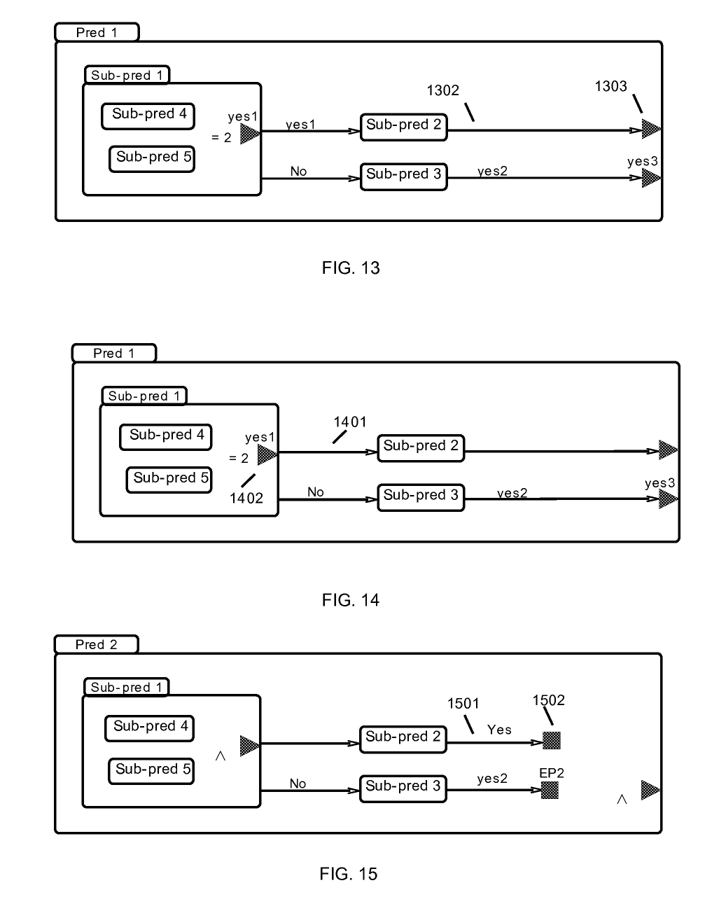

2) Since “Yes” is typically a default choice, it can be omitted in the diagram. In other words, the lack of any name specified in the place where “Yes” can be specified is equivalent to specifying “Yes” there. For example, FIG. 13 shows a simplified version of the same “Pred1” Composite-predicate as shown in FIG. 12. The “Yes” name of the Exit-point 1203 and the “Yes” Transition-condition 1202 are omitted in FIG. 13.

3) When an Exit-point is explicitly shown in a source sub-predicate, the Transition-condition of the Transition-arrow leading from the Exit-point to the next sub-predicate can be omitted. For example, Exit-point 1402 is explicitly shown in FIG. 14, hence, the Transition-condition of the Transition-arrow 1401 can be omitted.

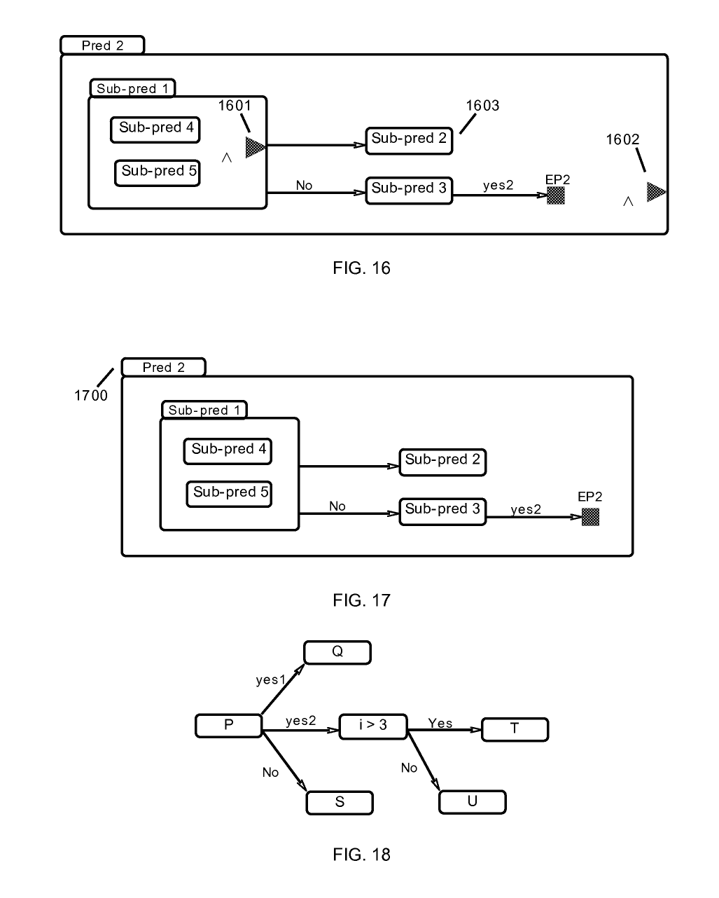

4) If the Transition-condition of a Transition-arrow leading to an End-point is “Yes”, the Transition-arrow, the Transition-condition and the End-point may be omitted all together. For example, as shown in FIG. 15, the “Pred2” Composite-predicate has a sub-predicate, “Sub-pred2”, that has a Transition-arrow 1501 with “Yes” as its Transition-condition leading to an End-point 1502. These Transition-arrow, Transition-condition and End-point can all be omitted as shown in FIG. 16. From another perspective, if a sequential sub-predicate, such as “Sub-pred2” 1603, does not have any user defined outgoing Transition-arrow, an outgoing Transition-arrow, with “Yes” as its Transition-condition, pointing to a “Yes” End-point is assumed.

5) If a Composite-predicate has only one user defined Exit-point and it has logical “AND” as its Exit-condition, this Exit-point may be omitted. For example, FIG. 17 shows the same “Pred2” Composite-predicate with two Exit-points omitted, since each of them 1601, 1602 has the “̂” Exit-conditions as shown in FIG. 16. From another perspective, if a Composite-predicate, such as “Pred2” 1700, does not have any user defined Exit-point, an Exit-point with the “̂” Exit-condition and the “Yes” name is assumed.

So far, the specification of a Composite-predicate has been presented. However, as described earlier, when Predicates are used to define an application system behavior, those Predicates may be composite or simple. To complete the description of Predicates, the characteristics of a Simple-predicate are also described herein.

Unlike a Composite-predicate, a Simple-predicate cannot be further divided into smaller components. Hence, it is represented as a box with its name or the simple predicate expression, such as “i>3”, inside the box. For example, as shown in FIG. 18, “P”, “Q”, “i>3”, “S”, “T” and “U” are all Simple-predicates.

As one kind of Predicate, a Simple-predicate does share some common characteristics with a Composite-predicate. Similar to a Composite-predicate, a Simple-predicate may also have multiple possible positive Result values and a non-positive Result value. Each of these Result values may be viewed as being associated with one of many abstract Exit-points defined for the Simple-predicate. The name of these abstract Exit-points may be specified by the Transition-condition of a Transition-arrow leading from the Simple-predicate to a target sub-predicate. For example, as shown in FIG. 18, after Simple-predicate, “P”, is evaluated, if its Result has a value that is associated with the “yes1” abstract Exit-point of “P”, the “Q” Predicate is the next one to be evaluated. If its Result has a value that is associated with the “yes2” abstract Exit-point of “P”, the “i>3” Predicate is the next one to be evaluated. If the Result of “P” is non-positive, the “S” Predicate is to be evaluated next.

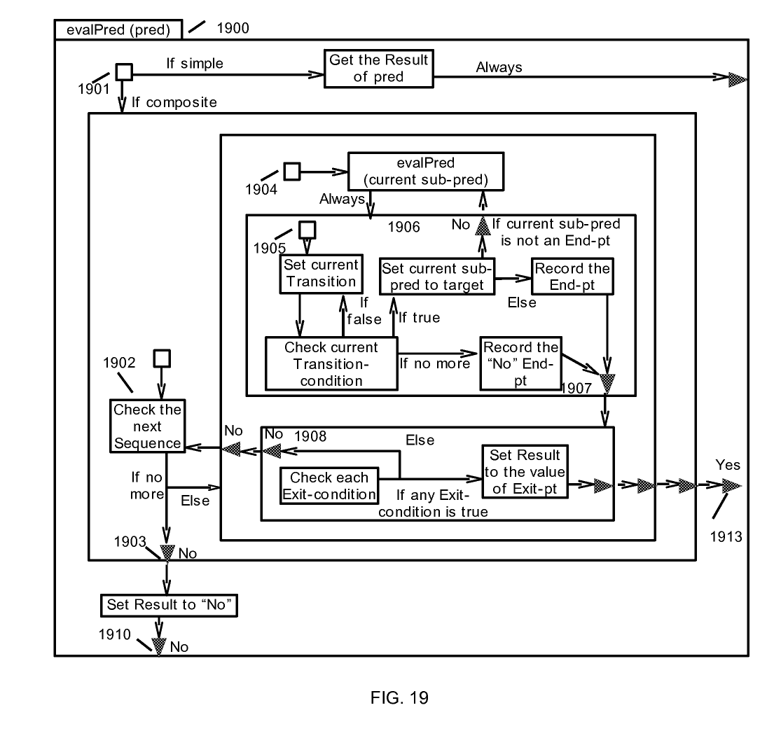

The evaluation procedure, “evalPred”, for a Predicate named “pred” is shown graphically in a DSC diagram in FIG. 19. Since each direct Exit-point in a Composite-predicate can be converted to an indirect Exit-point, for brevity, this procedure assumes that all direct Exit-points have already been converted to indirect Exit-points. Hence, the procedure only deals with indirect Exit-points. In addition, since each parallel sub-predicate can be treated as a Sequence, the procedure only needs to evaluate Sequences.

When the procedure starts, it starts from the Begin-point 1901. If “pred” is a Simple-predicate, “pred” is evaluated directly, its Result attribute is set, and then exits. If “pred” is composite, the current Sequence is checked 1902. If there is no more Sequence, the Sequence evaluation procedure exits at 1903. Else, the Sequence is evaluated starting from the Begin-point 1904. The same evaluation procedure, “evalpred” 1900, is recursively invoked for the current sub-predicate in the Sequence.

After the current sub-predicate in the Sequence is evaluated, it starts from the Begin-point 1905 to set the current Transition-arrow to the first one and check each Transition-condition. There are three possible Transitions: 1) If the Transition-condition is false, it sets the current Transition-arrow to the next one and repeats. 2) If the Transition-condition is true, it sets the current sub-predicate to the target of the Transition-arrow. If the new current sub-predicate is not an End-point, the procedure exits at 1906 and repeats for the new current sub-predicate. Else [if the new current sub-predicate is an End-point], it records the end-value of the End-point and exits at 1907 to check each Exit-condition. 3) If there is no more Transition-condition to check, the procedure records the end-value of the implicit End-point and then exits at 1907.

After each Sequence is evaluated (exited from 1907), the procedure checks each Exit-condition. If any Exit-condition is true, it sets the Result to the exit-value of the corresponding Exit-point and the entire evaluation exits at 1913. Else, it exits at 1908, and continues to check the next Sequence 1902.

After all Sequences are evaluated and if no Exit-condition is met, go set the Result for the “pred” Predicate to the exit-value associated with the “No” Exit-point and the entire evaluation exits at 1910.

Having described the functionality of a Composite-predicate using various abstract examples, to further clarify how the Composite-predicate may be applied in a software, let's look at a concrete example. Let's assume that a charity organization needs to decide whether to approve a grant application or not, and if an applicant is qualified, how much should a grant be. This charity organization may use Composite-predicate, “Grant” 520, as shown in FIG. 5B to evaluate each application. If an applicant is female and pregnant, “Grant” evaluates to the exit-value associated with the “$400” direct Exit-point (exiting at 525 in FIG. 5B). If an applicant's age is less than 12, “Grant” evaluates to the exit-value associated with the “$400” indirect Exit-point (ending at 522 and then exiting at 526 in FIG. 5B). If an applicant's age is not less than 12 but is poor, “Grant” evaluates to the exit-value associated with the “$400” indirect Exit-point (ending at 523 and then exiting at 526 in FIG. 5B). If an applicant is not younger than 12 years of age and is not poor, but is a citizen of Kenya or Congo, “Grant” evaluates to the exit-value associated with the “$100” indirect Exit-point (ending at 524 and then exiting at 527 in FIG. 5B). If an applicant does not fall into any of the above categories, “Grant” evaluates to the exit-value associated with the implicit “No” Exit-point.

For further clarification of this invention, the equivalent pseudo code of the “Grant” predicate (520 in FIG. 5B) may look like the following:

```
Grant ( ) {
    if (sex == “Female” && status == “pregnant”) return grant400;
    if (age < 12) return grant400;
    if (age >=12 && status == “poor”) return grant400;
    if (age >= 12 && status != “poor”) {
        if (citizen == “Kenya” || “Congo”)) return grant100;
    }
    return noGrant;
}
```

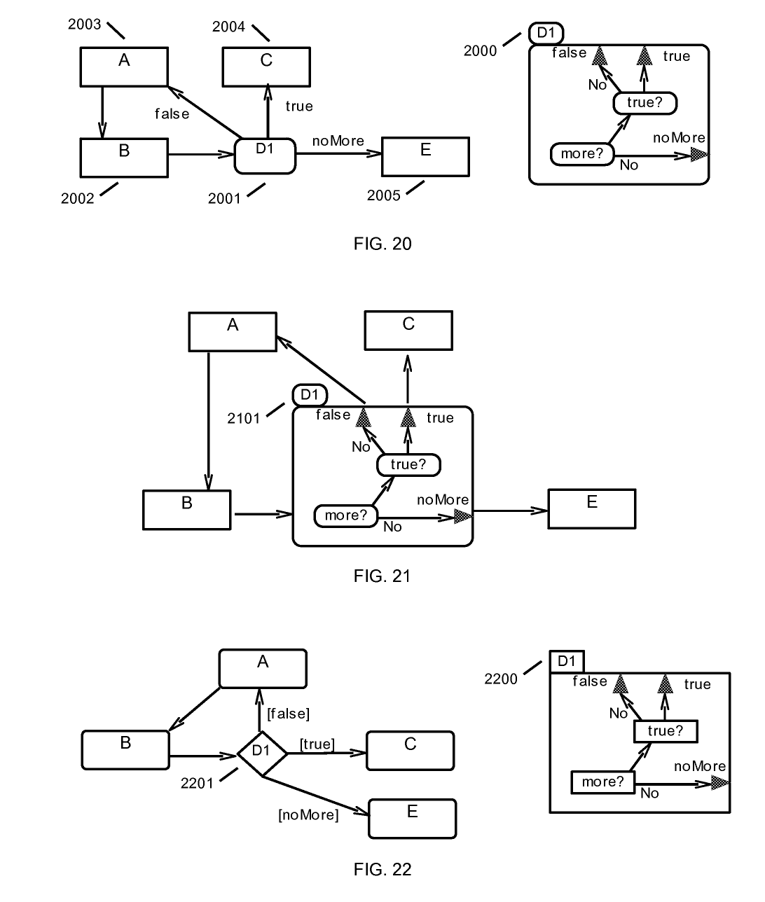

The Composite-predicate described in the present invention can be used in an extended DSC diagram in several ways. 1) The Composite-predicate can be used to specify a decision point to choose one among many next sub-DS's to execute next. For example, as shown in FIG. 20, Composite-predicate, “D1” 2000, has two sequential sub-predicates forming one Sequence. These sub-predicates are “more?” and “true?”. The “D1” Composite-predicate first evaluates the “more?” sub-predicate. If the Result of “more?” is non-positive, “D1” exits at the “noMore” Exit-point. Else, the “true?” sub-predicate is the next one to be evaluated. If the Result of “true?” is non-positive, “D1” exits at the “false” Exit-point. Else, it exits at the “true” Exit-point.

As shown in FIG. 20, with the “D1” Composite-predicate 2000 specified, the Composite-predicate name “D1” can then be used as a decision point 2001 after “B” 2002 is performed. Decision point, “D1” 2001, has three outgoing arrows, namely “false”, “true”, and “noMore”. If “D1” is evaluated with the Result value of “false”, “A” 2003 is the next one to execute. If “D1” is evaluated with the Result value of “true”, “C” 2004 is the next one to execute. If “D1” is evaluated with the “noMore” Result value, “E” 2005 is the next one to execute.

2) The detail of a Composite-predicate can also be specified at the decision point. For example, FIG. 21 shows the decision point is defined as a Composite-predicate “D1” 2101 with three outgoing arrows, and each of these outgoing arrows leads from one Exit-point of the Composite-predicate to one next sub-DS.

### Using a Composite-Predicate in Another Graphical Language

In addition to extending the DSC with the graphical predicate facility, a Composite-predicate of the present invention can also be used to replace a textual boolean expression in a flowchart, such as UML Activity Diagram or BPMN. Hereafter, BPMN terminology is adopted when describing components of BPMN and UML terminology is adopted when describing components of UML.

In the case of UML Activity Diagrams, the same behavior described in FIG. 20 can be specified in an extended version of UML Activity Diagrams as shown in FIG. 22. The decision node 2201 is shown with the name of the “D1” Composite-predicate, while the “D1” Composite-predicate 2200 is defined as the diagram on the right in FIG. 22. Note that since UML Activity Diagrams use a rectangle with rounded corners to represent an Activity, in order to differentiate Predicates from other regular Activities, a predicate 2200 may be represented by a rectangle with sharp corners.

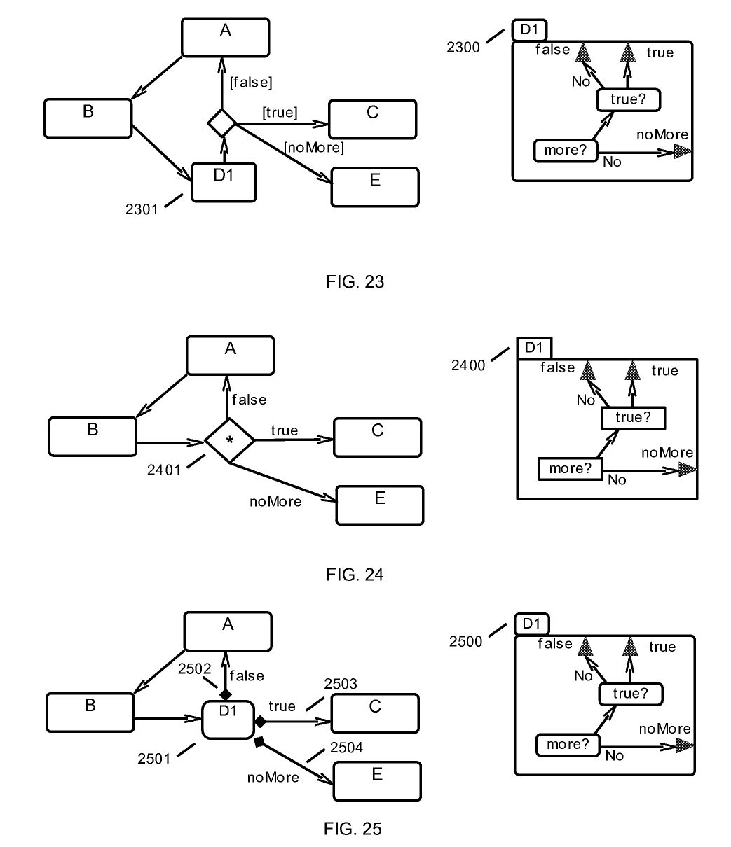

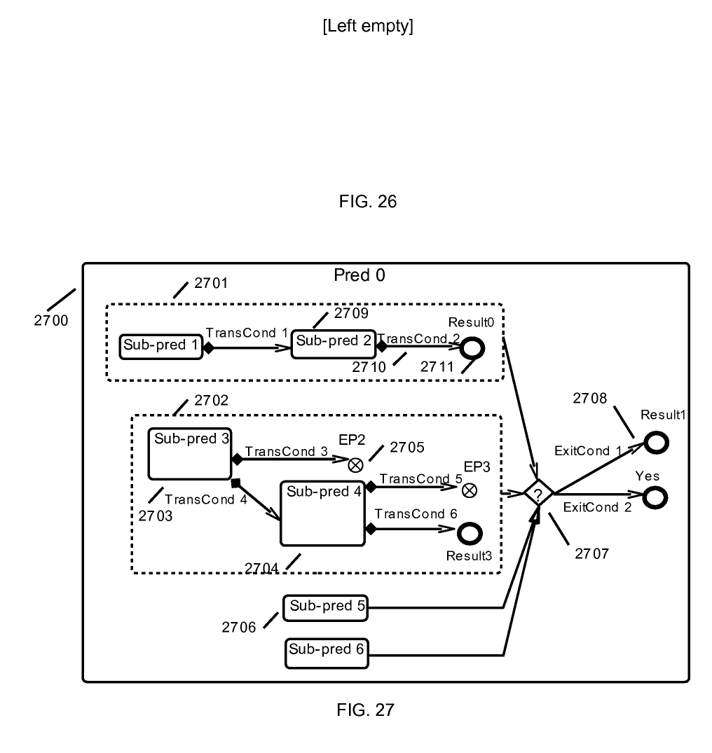

Another way to use the Composite-Predicate in UML Activity Diagrams is to treat the Composite-Predicate as a regular Activity node. FIG. 23 shows the “D1” Composite-predicate 2300 may be used as a target Activity 2301 of the ActivityEdge leading from the “B” Activity. An outgoing ActivityEdge then links the “D1” Activity to a decision node, which then makes a decision to select one of its three outgoing ActivityEdges based on the result of the “D1” Activity 2301.

In the case of BPMN, the same behavior described in FIG. 20 can be specified in an extended version of BPMN diagram as shown in FIG. 24. The “D1” Composite-predicate 2400 may be used to specify the OutgoingCondition attribute of a Complex Gateway 2401 of BPMN. The Complex Gateway may have multiple outgoing sequence flows and each particular Result value of the Composite-predicate may be specified in the ConditionExpression attribute of these sequence flows. For example, “false”, “true” and “noMore” in FIG. 24 are outgoing sequence flows of the Complex Gateway “D1” 2401. Note that since BPMN uses a rectangle with rounded corners to represent an Activity, in order to differentiate Composite-predicates from other regular Activities, a Composite-predicate, such as “D1” 2400, may be represented by a rectangle with sharp corners.

Another way to use the Composite-predicate of this invention in BPMN is to treat it as a regular Activity. For example, as shown in FIG. 25, the “D1” Composite-predicate 2500 is used as the target Activity 2501 of the outgoing sequence flow of the “B” Activity. “D1” 2501 has three outgoing conditional sequence flows, namely 2502, 2503 and 2504. The ConditionExpression attribute of conditional sequence flows specifies that if the “D1” Composite-predicate is evaluated to the particular Result value, the associated sequence flow would proceed. For example, the “false” ConditionExpression attribute specifies that the Result of “D1” has the exit-value associated with the “false” Exit-point of “D1”. If that expression is true, the “A” Activity will be the next to execute.

Although a flowchart, such as UML Activity diagram or BPMN, can be extended to support the graphical notation of the Composite-predicate as described above, this may not be desirable for some designers, since the graphical notation described above uses a different convention and style from the native flowchart style. It would be confusing for a designer to specify the application behavior in its native graphical style and then switch to the DSC style as described above in this invention when the designer needs to specify a Composite-predicate. A better approach is to extend an existing flowchart to support the Composite-predicate in a more consistent style as the native one.

### Emulating a Composite-Predicate in an Extended Version of BPMN

This section describes how BPMN may be extended to emulate a Composite-predicate in a style more consistent to BPMN than the DSC style. In order to emulate Composite-predicates, following new components may be added to BPMN as extensions: 1) the Composite-predicate-activity that emulates a Composite-predicate, 2) the Sequence-box that emulates a Sequence, and 3) the Simple-predicate-activity that emulates a simple sub-predicate in a Composite-predicate. In addition, a way to emulate the functionalities of the Result attribute, End-points and Exit-points is required. For brevity, both Composite-predicate-activity and Simple-predicate-activity are also called Predicate-activities.

A Composite-predicate-activity is used for emulating a Composite-predicate. A Composite-predicate-activity is a specialized sub-process added to BPMN. It may have a ResultValue attribute to emulate the Result attribute of a Composite-predicate for storing the result value after it exits. In addition, a Composite-predicate-activity may contain multiple Sequence-boxes, multiple Predicate-activities, where each of them emulating a parallel sub-predicate, an Exit Gateway and multiple Final Events. For example, the “Pred0” Composite-predicate 400 as shown in FIG. 4 may be emulated by a Composite-predicate-activity 2700 in BPMN as shown in FIG. 27.

The Composite-predicate-activity contains one Sequence-box for emulating each Sequence of a Composite-predicate. This Sequence-box is similar to other regular Activities in BPMN except that reaching an End Event inside of it will terminate not only the Sequence-box but also the containing Composite-predicate-activity that emulates the Composite-predicate. To distinguish it from other regular Activities, this Sequence-box may be shown as a dashed box 2701 as shown in FIG. 27. Each Sequence in the Composite-predicate is emulated by one such Sequence-box with a sequence flow leading to a joining Gateway. For example, one Sequence-box 2701 emulates the first Sequence, while another 2702 emulates the second Sequence in the “Pred0” Composite-predicate in FIG. 4. Both of these Sequence-boxes have a sequence flow leading to a joining Gateway 2707.

The whole Sequence in a Composite-predicate may be emulated in BPMN by a series of Predicate-activities inside the Sequence-box, where each of them emulates a sequential sub-predicate in the Sequence. If a sequential sub-predicate is a Simple-predicate, it is emulated by a Simple-predicate-activity. Otherwise, it is emulated by a Composite-predicate-activity. These Predicate-activities inside of a Sequence-box are linked by conditional sequence flows. For example, Predicate-activities, “Sub-pred3” 2703 and “Sub-pred4” 2704 in FIG. 27, emulate sub-predicates of the same names in FIG. 4. The “TransCond4” Transition in FIG. 4 is emulated by the conditional sequence flow, “TransCond4”, leading from the source Predicate-activity, “Sub-pred3” 2703, to its target Predicate-activity, “Sub-pred4” 2704 in FIG. 27. The ConditionExpression attribute associated with each conditional sequence flow describes the Transition-condition associated with the Transition in the Composite-predicate.

In order to emulate an End-point in a Sequence, a new Event type, End-point-event, may be added to BPMN. An End-point-event has the same name as the End-point being emulated. When an End-point-event in a Sequence-box is reached, the Sequence-box terminates, and the name or its internal ID of the End-point-event just reached is recorded so that later Exit-conditions can check on the termination status of each Sequence in the Composite-predicate. To distinguish it from other Events in BPMN, an End-point-event may be shown as [symbol] . A Transition-arrow pointing to an End-point in a Composite-predicate is emulated by a conditional sequence flow pointing to such an End-point-event. For example, the “EP2” End-point in FIG. 4 is emulated by the End-point-event 2705 with a name of “EP2” in FIG. 27.

Although BPMN requires that all sequence flows be explicitly specified, in order to simplify the diagram, the behavior of implicit End-points of a Composite-predicate is supported by the Sequence-box without showing any implicit End-point in the extended BPMN diagram. In other words, a conditional sequence flow with “else” specified in its ConditionExpression attribute leading to an implicit End-point-event with the name of “No” is automatically added to each source Predicate-activity. After a source Predicate-activity exits, if none of its user defined Transition-conditions is true, the Sequence-box terminates at the implicit “No” End-point, and the name or its internal ID of the implicit End-point-event is recorded for later use. For example, “Sub-pred3” 2703 in FIG. 27 has two Transition-conditions, namely “TransCond3” and “TransCond4”. Although not explicitly shown, “Sub-pred3” also has another implicit conditional sequence flow leading to an implicit End-point-event named “No”. Hence, after “Sub-pred3” 2703 exits, if none of “TransCond3” and “TransCond4” is true, the Sequence-box 2702 terminates at the implicit End-point-event.

If a parallel sub-predicate in a Composite-predicate is a Simple-predicate, it is emulated by a Simple-predicate-activity. Otherwise, it is emulated by a Composite-predicate-activity. Either one has an outgoing sequence flow pointing to a joining Gateway. For example, the parallel sub-predicate, “Sub-pred5” in FIG. 4, is emulated by “Sub-predicate5” 2706 in FIG. 27, which is either a Simple-predicate-activity or a Composite-predicate depending on whether the parallel sub-predicate being emulated is simple or composite. It has a sequence flow leading from it to the joining Gateway 2707.

The joining Gateway that combines all Sequence-boxes and Predicate-activities emulating parallel sub-predicates is called an Exit-gateway, which is a new Gateway type added to BPMN. To differentiate it from other Gateways in BPMN, the Exit-gateway may be shown as a diamond with “?” inside. An Exit-gateway has multiple incoming and multiple outgoing sequence flows. Each of its incoming sequence flows is linked to it from a Sequence-box or a parallel sub-predicate emulating Predicate-activity. Each of its outgoing sequence flows leads to an End Event that emulates an indirect Exit-point of the Composite-predicate being emulated. Each outgoing sequence flow has an ConditionExpression attribute that specifies the Exit-condition associated with the Exit-point being emulated by the End Event pointed to by the sequence flow. For example, the “Result1” Exit-point in FIG. 4 is emulated by the “Result1” End Event in FIG. 27, and the “ExitCond 1” Exit-condition is emulated by the ConditionExpression attribute, “ExitCond 1”, associated with the outgoing sequence flow 2708 in FIG. 27.

The behavior of the Exit-gateway is to wait until a token is received from every Sequence-box and parallel sub-predicate emulating Activity and then select one of its outgoing sequence flows. If any ConditionExpression attribute is true, its sequence flow is selected and the End Event that is pointed to by the selected sequence flow starts to evaluate. When the End Event starts, the containing Composite-predicate-activity exits and sets its ResultValue attribute to the exit-value associated with the Exit-point being emulated.

The Exit-point's name is emulated by specifying its name in the Name attribute of an End Event emulating the Exit-point. For example, each of End Events, “Result1” and “Yes” in FIG. 27, corresponds to each Exit-point name of the same in FIG. 4.

To emulate the full functionalities of a Composite-predicate, the ConditionExpression attribute of each outgoing sequence flow may specify the number of Sequences that have been evaluated to a positive value, including Exactly-N, At-least-N, and At-most-N as described earlier. The syntax of the ConditionExpression attribute needs to follow the language specified in “ExpressionLanguage” of the Business Process Diagram attribute in BPMN.

A direct Exit-point in a Composite-predicate may be emulated in BPMN by an End Event directly pointed to by a conditional sequence flow leading from the Predicate-activity emulating its source sequential sub-predicate. This End Event may be shown inside of the Sequence-box emulating the Sequence that contains the source sequential sub-predicate emulating Predicate-activity. For example, as shown in FIG. 27, “Sub-pred2” 2709 has a conditional sequence flow 2710 pointing directly to the “Result0” End Event 2711, which emulates the direct Exit-point, “Result0” 410 in FIG. 4. After “Sub-pred2” 2709 is evaluated, if “TransCond2” 2710 is true, “Result0” 2711 is reached. The “Result0” End Event 2711 terminates the containing Composite-predicate-activity and sets its ResultValue to the exit-value associated with the “Result0” Exit-point in FIG. 4.

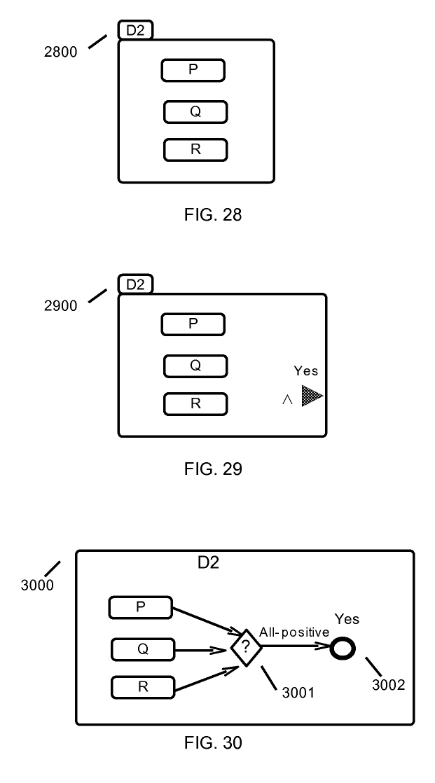

As described earlier, if there is no user defined Exit-point in a Composite-predicate, an Exit-point with its Exit-condition specified as “̂” and its name specified as “Yes” is assumed. This Exit-point is emulated by a conditional-sequence-flow pointing from the Exit-gateway to an End Event with “Yes” specified in its name attribute. The ConditionExpression attribute of this conditional sequence flow is specified in the expression language syntax representing “if all Sequence-boxes and Predicate-activities emulating parallel sub-predicates are evaluated to positive results”. For example, FIG. 28 shows, in the DSC notation, a Composite-predicate, “D2” 2800, that has three sub-predicates, “P”, “Q” and “R”, without any user defined Exit-point. FIG. 29 shows in DSC the same Composite-predicate “D2” 2900 with the “Yes” Exit-point, which has “̂” as its Exit-condition, explicitly shown. FIG. 30 shows how this Composite-predicate, “D2” 2900, may be emulated as a Composite-predicate-activity 3000 in BPMN. In particular, the “Yes” Exit-point is emulated by a conditional sequence flow pointing from the Exit-gateway 3001 to the End Event 3002 with “Yes” specified in its name attribute. The ConditionExpression attribute of this conditional sequence flow is “All-positive”, which specifies the condition as “if all Sequence-boxes and Predicate-activities emulating parallel sub-predicates are evaluated to positive results” following the syntax of the expression language specified in the Business Process Diagram in BPMN.

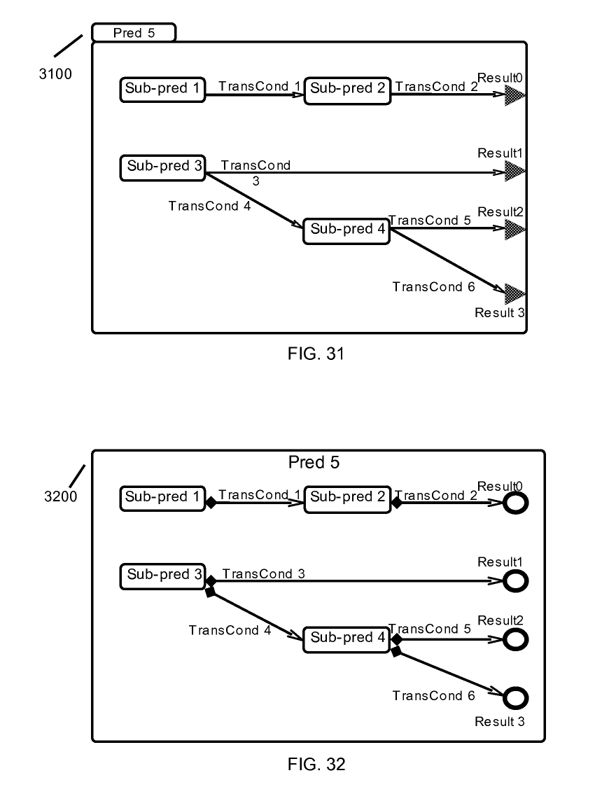

If a Composite-predicate has only direct Exit-points, this Composite-predicate may be emulated in BPMN without the need for the Exit-gateway. In addition, the dashed box for each Sequence-box may be omitted. For example, FIG. 31 shows in DSC a Composite-predicate, “Pred5” 3100, with two Sequences and four direct Exit-points, namely “Result0”, “Result1”, “Result2” and “Result3”. “Pred5” 3100 in FIG. 31 may be emulated by the “Pred5” Composite-predicate-activity 3200 in BPMN as shown in FIG. 32 without the Exit-gateway. Each of “Sub-pred1”, “Sub-pred2”, “Sub-pred3”, and “Sub-pred4” in FIG. 32 is a Predicate-activity that emulates a sub-predicate of the “Pred5” Composite-predicate 3100 in FIG. 31 with the same name.

A Simple-predicate may be emulated by a Simple-predicate-activity in BPMN. A Simple-predicate-activity is a special type of Task in BPMN. Like a Composite-predicate-activity, a Simple-predicate-activity may have a ResultValue attribute. After it completes, its ResultValue attribute may be set to a value, which is either a positive type or a non-positive type.

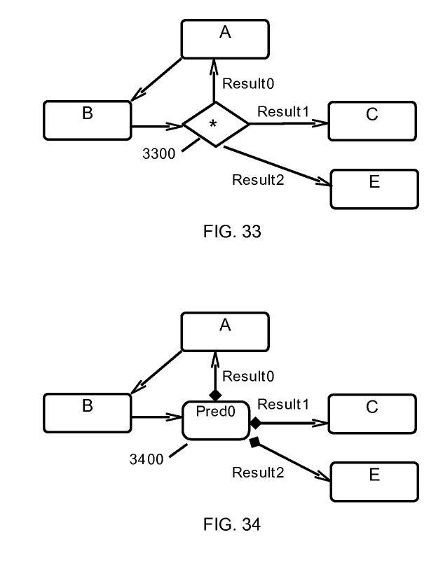

A Composite-predicate-activity may be used in an extended BPMN similar to how a Composite-predicate may be used as shown in FIG. 24. A Composite-predicate-activity may be used to specify the OutgoingCondition attribute of a Complex Gateway in BPMN, and then the Complex Gateway can be used as a decision gateway. For example, the OutgoingCondition attribute of the Complex Gateway 3300 in FIG. 33 is specified as the “Pred0” Composite-predicate-activity, 2700 in FIG. 27. Depending on the value of its ResultValue attribute, one of “A”, “C” and “E” is selected as the next Activity to proceed.

FIG. 34 shows another way to use a Composite-predicate-activity for making decisions. Similar to how a Composite-predicate may be used as a regular Activity as shown in FIG. 25, the “Pred0” Composite-predicate-activity 2700 in FIG. 27 is used as the target Activity 3400 of the outgoing sequence flow of the “B” Activity in FIG. 34. The “Pred0” Composite-predicate-activity has three outgoing conditional sequence flows. The ConditionExpression attribute of each of these conditional sequence flows specifies that if the ResultValue attribute of “Pred0” has the exit-value associated with a particular Exit-point, the associated sequence flow would proceed.

### Emulating a Composite-Predicate in an Extended Version of UML Activity Diagram

This section describes how UML Activity Diagram may be extended to emulate a Composite-predicate in a style more consistent to UML than the DSC style. In order to emulate Composite-predicates, following new components may be added to UML as extensions: 1) the Composite-predicate-node that emulates a Composite-predicate, and 3) the Sequence-box that emulates a Sequence, and 3) the Simple-predicate-node that emulates a simple sub-predicate. In addition, a way to emulate the functionalities of the Result attribute, End-points and Exit-points is required. For brevity, both Composite-predicate-node and Simple-predicate-node are also called Predicate-nodes.

A Composite-predicate-node is used for emulating a Composite-predicate. A Composite-predicate-node is a specialized Activity added to UML. It may have a ResultValue attribute to emulate the Result attribute of a Composite-predicate for storing the result value after it terminates. In addition, a Composite-predicate-node contains multiple Sequence-nodes, multiple parallel sub-predicate emulating Predicate-nodes, each of them being either a Simple-predicate-node or a Composite-predicate-node, a join node, a decision node and multiple ActivityFinalNodes. For example, the “Pred0” Composite-predicate 400 in FIG. 4 may be emulated by a Composite-predicate-node 3500 in UML as shown in FIG. 35.

The Composite-predicate-node contains one Sequence-box for emulating each Sequence of a Composite-predicate. This Sequence-box is similar to other regular Activities in UML except that when an ActivityFinalNode inside of it is reached, not only the Sequence-box but also the containing Composite-predicate-node will terminate. To distinguish it from other regular Activities, this Sequence-box may be shown as a dashed box 3501 as shown in FIG. 35. Each Sequence in the Composite-predicate is emulated by one such Sequence-box with an outgoing ActivityEdge leading to a join node. For example, one Sequence-box 3501 in FIG. 35 emulates the first Sequence, while another Sequence-box 3502 emulates the second Sequence in the “Pred0” Composite-predicate in FIG. 4. Each of these Sequence-boxes has an outgoing ActivityEdge leading to a join node 3503.

The whole Sequence in a Composite-predicate may be emulated in UML by a series of Predicate-nodes inside the Sequence-box, where each of them emulates a sequential sub-predicate in the Sequence. For example, “Sub-pred3” 3503 and “Sub-pred4” 3504 in FIG. 35, emulate those sub-predicates of the same names in the second Sequence of the “Pred0” Composite-DS 400 in FIG. 4. If “Sub-pred3” in FIG. 4 is a Simple-predicate, “Sub-pred3” 3503 in FIG. 35 is a Simple-predicate-node. Otherwise, “Sub-pred3” 3503 is a Composite-predicate-node.

Inside of a Sequence, a Transition-arrow leading from a source to a target is emulated in UML by an ActivityEdge leading from the Predicate-node emulating the source to a decision node, which has one outgoing ActivityEdge emulating the Transition-arrow. In addition, the Transition-condition associated with the Transition-arrow is emulated in UML by the guard of the outgoing ActivityEdge that emulates the Transition-arrow. For example, Transition-arrows with Transition-conditions of “TransCond3” and “TransCond4” in FIG. 4 are emulated by an ActivityEdge leading to a decision node 3505 followed by one outgoing ActivityEdge with [TransCond3] as its guard and another outgoing ActivityEdge with [TransCond4] as its guard as shown in FIG. 35.

An End-point in a Sequence may be emulated by a FlowFinalNode in UML. For example, the “EP2” End-point in FIG. 4 is emulated by FlowFinalNode with the same name 3506 in FIG. 35. When the FlowFinalNode is reached, the Sequence-box is terminated, a token is forwarded to a join node, and the name or its internal ID of the End-point being emulated is recorded. This information will be used later by Exit-conditions.

The behavior of implicit End-points in a Sequence may be emulated in UML by the following: When all guards of every outgoing ActivityEdge emulating Transition-conditions of a source sub-predicate have failed, the Sequence-box is terminated and the implicit End-point's name or its internal ID is recorded for later examination by Exit-conditions. For example, as shown in FIG. 35, after “Sub-pred3” 3503 completes, the guard of each outgoing ActivityEdge, such as [TrasnsCond3] and [TransCond4], is checked. If neither of them is true, the Sequence-box 3502 is terminated and the implicit End-point's name or its internal ID is recorded.

A direct Exit-point is emulated by an ActivityFinalNode inside of the Sequence-box. When the ActivityFinalNode executes, it terminates the containing Composite-predicate-node, and sets its ResultValue attribute to the exit-value associated with the Exit-point emulated by the ActivityFinalNode. For example, the direct Exit-point, “Result0” 410 in FIG. 4, is emulated by the outgoing ActivityEdge with the [TransCond2] guard that leads from the decision node 3509 to the “Result0” ActivityFinalNode 3510 in FIG. 35. If [TransCond2] is true, the “Result0” ActivityFinalNode starts to evaluate. When it starts, the “Result0” ActivityFinalNode terminates the “Pred0” Composite-predicate-node and sets its ResultValue attribute to the exit-value associated with the Exit-point emulated by the “Result0” ActivityFinalNode.

A parallel sub-predicate in a Composite-predicate is emulated in UML by a Predicate-node, which is either a Simple-predicate-node or a Composite-predicate-node depending on whether the sub-predicate being emulated is simple or composite. A parallel sub-predicate emulating Predicate-node has the same name as the sub-predicate being emulated, and one outgoing ActivityEdge leading to the join node. For example, parallel sub-predicate, “Sub-pred5” in FIG. 4, is emulated by the “Sub-pred5” node 3507 in FIG. 35. If the “Sub-pred5” sub-predicate in FIG. 4 is a Simple-predicate, “Sub-pred5” in FIG. 35 is a Simple-predicate-node. Otherwise, “Sub-pred5” in FIG. 35 is a Composite-predicate-node.

The join node merging all Sequence-boxes and Predicate-nodes emulating parallel sub-predicates in the Composite-predicate has a default JoinSpec of “and” so that when one token from every Sequence-box or parallel sub-predicate emulating Predicate-node has arrived, the join node completes. For example, the join node 3503 in FIG. 35 has the default JoinSpec.

Indirect Exit-points of a Composite-predicate may be emulated in UML by an ActivityEdge leading from the join node to a decision node, followed by outgoing ActivityEdges that lead to ActivityFinalNodes. Each indirect Exit-point is emulated by one outgoing ActivityEdge leading from the decision node to an ActivityFinalNode. The Exit-condition of each Exit-point is emulated by the guard of the outgoing ActivityEdge leading to the ActivityFinalNode that emulates the Exit-point. When an ActivityFinalNode executes, it terminates the containing Composite-predicate-node, and sets the ResultValue attribute of the containing Composite-predicate-node to the exit-value associated with the Exit-point emulated by the ActivityFinalNode. For example, as shown in FIG. 35, the join node 3503 has an outgoing ActivityEdge leading to a decision node 3508. The decision node 3508 has one outgoing ActivityEdge with the [ExitCond 1] guard that leads to the ActivityFinalNode named “Result1”. This emulates the “Result1” Exit-point 411 in the “Pred0” Composite-predicate 400 in FIG. 4. The decision node 3508 has another outgoing ActivityEdge with the “ExitCond 2” guard that leads to another ActivityFinalNode named “Yes”. This emulates the “Yes” Exit-point 412 in FIG. 4.

The behavior of the implicit Exit-point of a Composite-predicate may be emulated in UML by the following: If none of the guards of outgoing ActivityEdges of the decision node is true, the containing Composite-predicate-node is terminated and its ResultValue attribute is set to the exit-value associated with the implicit Exit-point. For example, as shown in FIG. 35, if neither [ExitCond 1] nor [ExitCond 2] is true, the “Pred0” Composite-predicate-node 3500 terminates with its ResultValue attribute set to the exit-value associated with the implicit Exit-point.

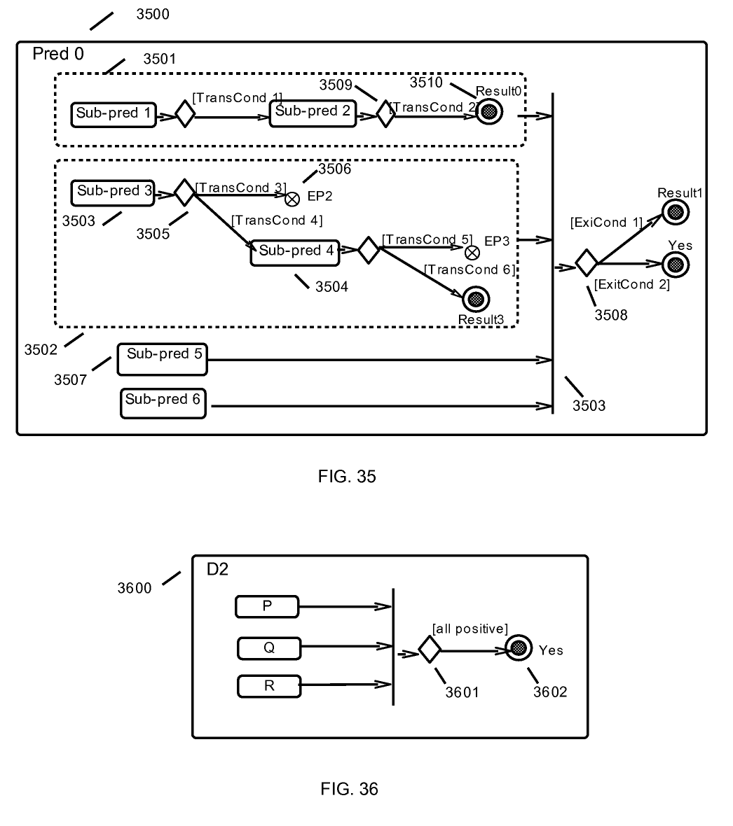

Based on the same approach, the “D2” Composite-predicate in FIG. 29 may be emulated by the “D2” Composite-predicate-node 3600 as shown in FIG. 36. In particular, the “Yes” Exit-point is emulated by an outgoing ActivityEdge pointing from the decision node 3601 to the “Yes” ActivityFinaleNode 3602, and the guard of the outgoing ActivityEdge is [All-positive], which specifies the condition of “if all Sequence-boxes and parallel sub-predicate emulating Predicate-nodes are evaluated to positive results”.

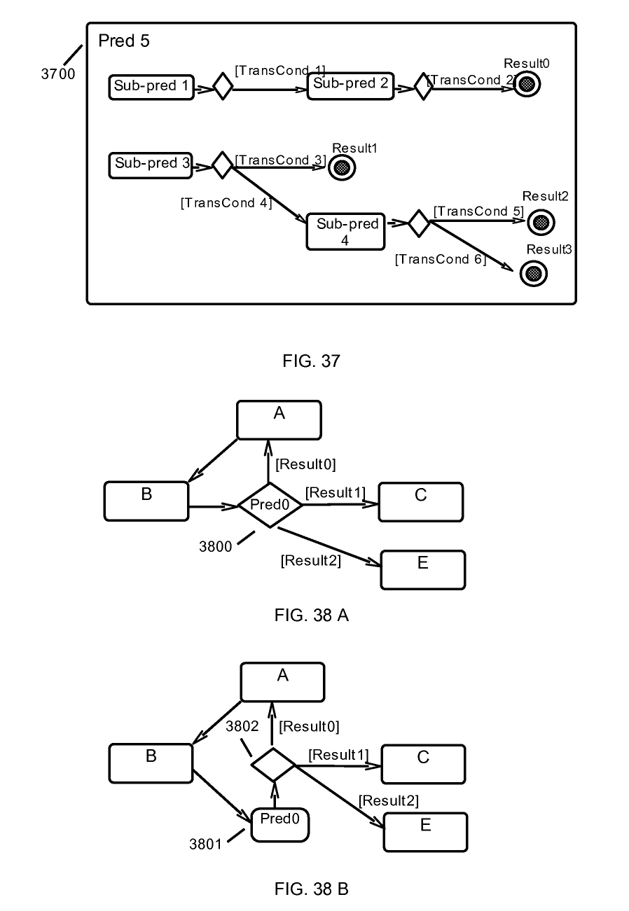

If all Exit-points of a Composite-predicate are direct Exit-points, this Composite-predicate may be emulated in UML without the need for the join node and the decision node. In addition, the dashed box for each Sequence-box can be omitted. For example, the “Pred5” Composite-predicate 3100 in FIG. 31 may be emulated by Composite-predicate-node named “Pred5” 3700 in UML as shown in FIG. 37. Each of “Sub-pred1”, “Sub-pred2”, “Sub-pred3”, and “Sub-pred4” in FIG. 37 emulates a sub-predicate of the “Pred5” Composite-predicate 3100 in FIG. 31 with the same name. Each ActivityFinalNode in FIG. 37, such as “Result0”, “Result1”, “Result2” and “Result3”, emulates an Exit-point of the “Pred5” Composite-predicate 3100 in FIG. 31 with the same name.

A simple sub-predicate in a Composite-predicate may be emulated by a Simple-predicate-node in UML. A Simple-predicate-node is a special type of Action in UML having a ResultValue attribute. After it completes, its ResultValue attribute is set to a value that is either a positive type or a non-positive type.

A Composite-predicate-node may be used in an extended UML just like how a Composite-predicate may be used as shown in FIG. 23. FIG. 38A shows how the “Pred0” Composite-predicate-node 3500 in FIG. 35, which emulates the “Pred0” Composite-predicate 400 in FIG. 4, may be used as a decision node 3800 for selecting the next Activity among “A”, “C” and “E” to proceed.

FIG. 38B shows another way to use a Composite-predicate-node for making decisions. Similar to how a Composite-predicate may be used as a regular Activity as shown in FIG. 25, the “Pred0” Composite-predicate-node 3500 in FIG. 35 is used as the target node 3801 of the outgoing sequence flow of the “B” Activity in FIG. 38B. The “Pred0” Composite-predicate-node 3801 has an outgoing edge leading to a decision node 3802 with three outgoing ActivityEdges. The guard of each of these ActivityEdges specifies that if the ResultValue attribute of “Pred0” 3801 is evaluated to the exit-value associated with a particular Exit-point, the associated ActivityEdge would proceed.

### Emulating a Composite-Predicate in a Graphical Language

The way how a Composite-predicate may be emulated in BPMN and UML as described above may be generalized to apply to other graphical languages with similar behavior modeling facilities.

In order to emulate Composite-predicates, following new components may be added to a graphical language as extensions: 1) a Composite-predicate-node emulating a Composite-predicate, 2) a Sequence-box emulating a Sequence, 3) an End-node emulating an End-point, 4) an Exit-node emulating an Exit-point, 5) a Join-fork-node combining all Sequence-boxes and Predicate-nodes emulating parallel sub-predicates in a Composite-predicate-node, and 6) a Simple-predicate-node emulating a Simple-predicate. For brevity, both Composite-predicate-node and Simple-predicate-node are also called Predicate-nodes.

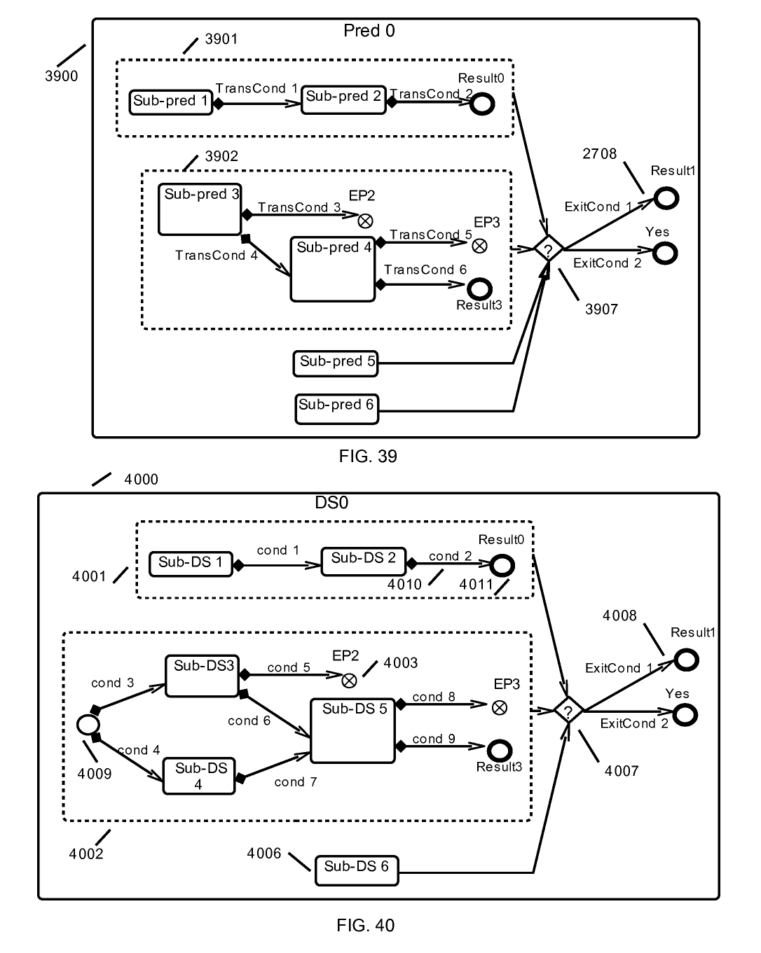

A Composite-predicate may be emulated by a Composite-predicate-node in a graphical language. A Composite-predicate-node may have a ResultValue attribute to emulate the Result attribute of a Composite-predicate for storing the result value after it terminates. Visually, a Composite-predicate-node may be shown as a container containing Sequence-boxes and parallel sub-predicate emulating Predicate-nodes. These Sequence-boxes and parallel sub-predicate emulating Predicate-nodes are combined by a Join-fork-node followed by conditional arrows pointing to multiple Exit-nodes. For example, Composite-predicate “Pred0” 400 in FIG. 4 may be emulated by a Composite-predicate-node, “Pred0” 3900, in a general graphical language as shown in FIG. 39. Sequence-boxes 3901 and 3902 and parallel sub-predicate emulating Predicate-nodes, “Sub-pred5” and “Sub-pred6”, are combined by a Join-fork-node 3907 followed by conditional arrows pointing to Exit-nodes, “Result1” and “Yes”. Note that a graphical language typically uses nodes to represent some activities to do and arrows to link one node to another. Since BPMN is similar to this general form of a graphical language, its graphical notation is used here as an example to demonstrate how a Composite-predicate may be emulated in a general graphical language.

A Sequence-box may contain various types of nodes, including sequential sub-predicate emulating Predicate-nodes, End-nodes and Exit-nodes, and each of these nodes are linked to other nodes by conditional arrows. For example, Sequence-box 3902 in FIG. 39 contains sequential sub-predicate emulating Predicate-nodes, “Sub-pred3” and “Sub-pred4”, End-nodes, “EP2” and “EP3”, and the “Result3” Exit-node.

A Composite-predicate-node can be nested, since each of these sub-predicate emulating Predicate-nodes can also be a Composite-predicate-node. For example, “Sub-pred3” in FIG. 39 may be a Composite-predicate-node.

A simple sub-predicate in a Composite-predicates may be emulated by a Simple-predicate-node, which is the element in the graphical language representing a single execution step, such as the Task in BPMN and the Action in UML. Like a Composite-predicate-node, a Simple-predicate-node has a ResultValue attribute. After it completes, its ResultValue attribute is set to a value of either a positive type or a non-positive type.

Although a component in a Composite-predicate-node is shown in a particular notation in the above description, each component may be shown in a different graphical notation in one embodiment of this invention without affecting its functionality. For example, an End-node is shown in FIG. 39 as [symbol] . In another embodiment, an End-node may be shown as a solid square. In yet another embodiment, an End-node may be shown as an empty square. As long as each of these component types are shown in a visually distinctive way so that one component type can be differentiated from another, the functionality of this invention is not diminished.

### Emulating a Composite-DS in a Graphical Language

So far, how a Composite-predicate may be emulated in another graphical language is described. The same technique may be used to emulated a Composite-DS in another graphical language, since a Composite-DS has nearly the same composition structure as a Composite-predicate.

A Composite-DS can be viewed as a generalization of a Composite-predicate without certain restrictions. While a Composite-predicate may have only one initial sub-predicate in each of its Sequences, a Composite-DS may have multiple initial sub-DS's in each of its Sequences. While Transition-conditions and Exit-conditions in a Composite-predicate are more limited, Transition-conditions and Exit-conditions in a Composite-DS may be specified in any Composite-predicate or Simple-predicate in addition to what can be specified for them in a Composite-predicate.

Due to the similarity between their compositional structures, the “evalPred” procedure 1900 for evaluating a Composite-predicate named “pred” as shown in FIG. 19 can be changed to an “evalDS (DS)” procedure for describing the execution of a Composite-DS named “DS” simply by replacing each “Pred” or “pred” in the procedure 1900 to “DS”. In other words, the evaluation of a Composite-DS is just like evaluating a Composite-predicate. The only difference is that while the evalPred (pred) procedure evaluates a Composite-predicate and all its sub-predicates, the evalDS (DS) procedure evaluates a Composite-DS and all its sub-DS's.

Therefore, the way how a Composite-predicate is emulated in various graphical languages described above may be generalized to apply to a Composite-DS. A graphical language typically uses nodes to represent some activities to do and arrows to link one node to another. Since BPMN is similar to this general form of a graphical language, its graphical notation is used here as an example to demonstrate how a Composite-DS may be emulated in a general graphical language.

In order to emulate a Composite-DS, following new components may be added to a graphical language as extensions: 1) a Composite-DS-node emulating a Composite-DS, 2) a Sequence-box emulating a Sequence in the Composite-DS, 3) a Begin-node emulating a Begin-point in the Sequence, 4) an End-node emulating an End-point in the Sequence, 5) an Exit-node emulating an Exit-point, 6) a Join-fork-node for combining all Sequence-boxes and DS-nodes emulating parallel sub-DS's in the Composite-DS, and 7) a Simple-DS-node emulating a Simple-DS. For brevity, both Composite-DS-node and Simple-DS-node are also called DS-nodes.

A Composite-DS-node is used for emulating a Composite-DS. A Composite-DS-node may have a ResultValue attribute to emulate the Result attribute of a Composite-DS for storing the result of its execution after it terminates. In addition, a Composite-DS-node may contain 1) multiple Sequence-boxes, 2) multiple DS-nodes emulating parallel sub-DS's in the Composite-DS, 3) a Join-fork-node, and 4) multiple indirect Exit-nodes. For example, the “DS0” Composite-DS 300 in FIG. 3 may be emulated by the “DS0” Composite-DS-node 4000 in a graphical language as shown in FIG. 40.

The Composite-DS-node contains one Sequence-box for emulating each Sequence of a Composite-DS. This Sequence-box may have 1) multiple DS-nodes emulating sequential sub-DS's in the Sequence, 2) arrows for linking DS-nodes in the same Sequence-box to each other, 3) multiple Begin-nodes, 4) multiple End-nodes, and 5) multiple direct Exit-nodes. A Sequence-box may be shown as a dashed box and is linked to the Join-fork-node by an outgoing arrow. For example, one Sequence-box 4001 in FIG. 40 emulates the first Sequence, while another Sequence-box 4002 emulates the second Sequence in the “DS0” Composite-DS 300 in FIG. 3. Each of these Sequence-boxes has an outgoing arrow leading to the Join-fork-node 4007 in FIG. 40.

Each DS-node in a Sequence-box emulates a sequential sub-DS in the Sequence. For example, within the Sequence-box 4002, “Sub-DS3”, “Sub-DS4” and “Sub-DS5” in FIG. 40 emulate those sub-DS's with the same names in the second Sequence of the “DS0” Composite-DS 300 in FIG. 3. If the sub-DS is a Simple-DS, it is emulated by a Simple-DS-node. Otherwise, it is emulated by a Composite-DS-node in the Sequence-box.

A Begin-point in a Sequence may be emulated by a Begin-node. For example, the Begin-point 309 in FIG. 3 is emulated by the Begin-node 4009 in FIG. 40.

Each Transition-arrow leading from a source to multiple targets in a Sequence is emulated by an arrow leading from the node emulating the source to a node emulating the target. In addition, the Transition-condition associated with each Transition-arrow is emulated by a Condition attribute associated with the arrow. The Condition attribute may be shown near the arrow. For example, the “cond3” Transition in FIG. 3 is emulated by an arrow leading from the Begin-node 4009 to “Sub-DS3” in FIG. 40 with its Condition attribute, “cond3”, shown near the arrow, and the “cond4” Transition in FIG. 3 is emulated by the arrow leading from the Begin-node 4009 to “Sub-DS4” in FIG. 40 with its Condition attribute, “cond4”, shown near the arrow. For another example, Transitions, “TransCond3” and “TransCond4” in FIG. 3, are emulated by an arrow leading to “EP2” 4003, and another arrow leading to “Sub-DS5” as shown in FIG. 40.

An End-point in a Sequence may be emulated by an End-node. To distinguish it from the Begin-node and the Exit-node, an End-node may be shown as [symbol] . For example, the “EP2” End-point 307 in FIG. 3 is emulated by the End-node with the same name 4003 in FIG. 40. When it is reached, the End-node emulating an End-point needs to record the name or an internal ID of the End-point that it emulates. This information will be used later by each Exit-condition to check if the Composite-DS should exit at that Exit-point or not.

The behavior of implicit End-points in a Sequence may be emulated by the following: After a source has completed, if the Condition attribute of every outgoing arrow of the source all have failed, the Sequence-box emulating the Sequence is terminated and the implicit End-point's name or its internal ID is recorded for later examination by Exit-conditions. For example, as shown in FIG. 40, after “Sub-DS3” completes, the Condition attribute of each outgoing arrow, such as “cond5” and “cond6”, is checked. If neither of them is true, the Sequence-box 4002 is terminated and the implicit End-point's name or its internal ID is recorded.

A direct Exit-point is emulated by an Exit-node inside of the Sequence-box. When this Exit-node executes, it terminates the containing Composite-DS-node, and sets its ResultValue attribute to the exit-value associated with the Exit-point emulated by the Exit-node. For example, the direct Exit-point, “Result0” 311 in FIG. 3, is emulated by the “Result0” Exit-node 4011 in FIG. 40. If “cond2” 4010 is true, the “Result0” Exit-node 4011 starts to evaluate, which terminates the “DS0” Composite-DS-node 4000 in FIG. 40 and sets its ResultValue attribute to the exit-value associated with the Exit-point emulated by the “Result0” Exit-node.

Each parallel sub-DS in the Composite-DS is emulated by either a Simple-DS-node or a Composite-DS-node, depending on whether the parallel sub-DS is simple or composite, and this sub-DS emulating DS-node has only one outgoing arrow leading to the Join-fork-node. For example, parallel sub-DS, “Sub-DS6” in FIG. 3, is emulated by “Sub-DS6” 4006 in FIG. 40, which is either a Composite-DS-node or a Simple-DS-node, depending on whether “Sub-DS6” in FIG. 3 is simple or composite.

The Join-fork-node merging all Sequence-boxes and DS-nodes emulating parallel sub-DS's in the Composite-DS has following behavior: When each Sequence-box or parallel sub-DS emulating DS-node ends, it checks the Condition attribute of all its outgoing arrows. If any of these Condition attributes is true, the containing Composite-DS exits and its ResultValue attribute is set to the exit-value associated with the Exit-point emulated by the Exit-node associated with the true Condition attribute. Otherwise, the Join-fork-node continues to wait. In this exemplary graphical language, the Join-fork-node is shown as a diamond with “?” inside. For example, the Join-fork-node 4007 in FIG. 40 merges Sequence-boxes, 4001 and 4002, and the “Sub-DS6” DS-node 4006.

An indirect Exit-point of a Composite-DS may be emulated by an Exit-node with an arrow leading from the Join-fork-node to it. The Exit-condition of each Exit-point is emulated by an Condition attribute associated with the arrow leading to the corresponding Exit-node. When an Exit-node executes, it terminates the containing Composite-DS-node, and sets the ResultValue attribute of the containing Composite-DS-node to the exit-value associated with the Exit-point being emulated. For example, as shown in FIG. 40, the Join-fork-node 4007 has an arrow 4008 with the Condition attribute, “ExitCond 1”, leading to the “Result1” Exit-node. This emulates the “Result1” Exit-point 312 in the “DS0” Composite-DS 300 in FIG. 3. To emulate the full functionalities of a Composite-DS, the Condition attribute of each arrow may be specified as one of the following: 1) a Simple-predicate-node, 2) a Composite-predicate-node, and 3) the number of Sequences that have been evaluated to positive end-values, including Exactly-N, At-least-N, and At-most-N.

The behavior of the implicit Exit-point of a Composite-DS may be emulated by the following: If none of the Condition attribute associated with those arrows leading to Exit-nodes is true, the containing Composite-DS-node is terminated and its ResultValue attribute is set to the exit-value associated with the implicit Exit-point. For example, as shown in FIG. 40, if neither “ExitCond 1” nor “ExitCond 2” is true, the “DS0” Composite-DS-node 4000 exits, and its ResultValue attribute is set to the exit-value associated with the implicit Exit-point.

If a sub-DS in a Composite-DS is a Simple-DS, it is emulated by a Simple-DS-node. Like a Composite-DS-node, a Simple-DS-node has a ResultValue attribute. After its operation completes, its ResultValue attribute may be set to a value that represents the status of its execution.

To emulate a Composite-DS in BPMN, some of those new constructs added to a graphical language may be further mapped to following new constructs added to BPMN: 1) the Simple-DS-node is mapped to a Simple-DS-activity, 2) the Composite-DS-node is mapped to a Composite-DS-activity, 3) the Begin-node is mapped to a Start Event of BPMN, 4) the End-node is mapped to an End-point-event, 5) the arrow is mapped to either a sequence flow or a conditional sequence flow of BPMN, 6) the Condition attribute of each arrow is mapped to the ConditionExpression attribute associated with each conditional sequence flow, 7) the Exit-node is mapped to an End Event of BPMN, and 8) the Join-fork-node is mapped to an Exit-gateway. For brevity, both Composite-DS-activity and Simple-DS-activity are also called DS-activities. More details are provided below.

The Simple-DS-activity is a special type of Task in BPMN having a ResultValue attribute. After it completes, the ResultValue attribute may be set to a value that represents the status of its execution.

The Composite-DS-activity is a specialized sub-process in BPMN. It may have a ResultValue attribute to emulate the Result attribute of a Composite-DS for storing the exit-value associated with the Exit-point where the Composite-DS being emulated is terminated. In addition, it contains multiple Sequence-boxes, multiple DS-activities emulating parallel sub-DS's in the Composite-DS, an Exit Gateway and multiple End Events.

The Sequence-box in BPMN is a specialized sub-process in BPMN. It is similar to other regular sub-processes in BPMN except that reaching an End Event inside of it will terminate not only the Sequence-box but also its containing Composite-DS-activity that emulates the Composite-DS. Each Sequence-box is linked to the Exit-gateway by a sequence flow.

Transition-arrows leading from a source to multiple targets are emulated in BPMN by conditional sequence flows that lead from the source to its targets. Here, a source may be a Start Event, a Simple-DS-activity or a Composite-DS-activity, whereas each target may be an End-point-event, a Simple-DS-activity or a Composite-DS-activity. In addition, the Transition-condition associated with each Transition-arrow is emulated in BPMN by the ConditionExpression attribute associated with each conditional sequence flow that emulates the Transition-arrow.

The End-point-event emulating an End-point is a new type of Event added to BPMN. It has a Name attribute that is set to the same name as the End-point being emulated. When an End-point-event in a Sequence-box is reached, the Sequence-box terminates. The name or its internal ID of the End-point-event just reached is recorded for later examination. To distinguish it from other Events in BPMN, an End-point-event may be shown as [symbol] .

The End Event emulating an Exit-point is a special End Event in BPMN. Its Name attribute is set to the same name as the Exit-point being emulated. The Exit-condition of an indirect Exit-point may be specified in the ConditionExpression attribute associated with the outgoing sequence flow leading to it from the Exit Gateway. This special End Event has the following behavior: When it is reached, it terminates the containing Composite-DS-activity, and sets the ResultValue attribute of the Composite-DS-activity to the exit-value associated with the Exit-point being emulated.

Each parallel sub-DS in a Composite-DS may be emulated in BPMN by either a Simple-DS-activity or a Composite-DS-activity, and it has one outgoing sequence flow leading to the Exit-gateway.

The Exit-gateway is a new Gateway type added to BPMN. It supports the behavior of the Join-fork-node as described earlier. To differentiate it from other Gateways in BPMN, the Exit-gateway is shown as a diamond with “?” inside.

By taking this emulation approach, the “DS0” Composite-DS 300 in FIG. 3 may be emulated by the “DS0” Composite-DS-activity 4000 in an extended version of BPMN as shown in FIG. 40.

To emulate a Composite-DS in UML Activity Diagrams, some of those new constructs added to a graphical language may be further mapped to following new constructs added to UML: 1) the Begin-node is mapped to an InitialNode, 2) the End-node is mapped to a FlowFinalNode, 3) the arrow is mapped to an ActivityEdge following a decision node, 4) the Condition attribute of each arrow is mapped to the guard associated with each ActivityEdge, 5) the Exit-node is mapped to an ActivityFinalNode, and 6) the Join-fork-node is mapped to a join node followed by an outgoing ActivityEdge leading to a decision node. For brevity, both Composite-DS-node and Simple-DS-node are also called DS-nodes. More details are provided below.

A Simple-DS-node in UML is a special type of Action that has a ResultValue attribute. After it completes, the ResultValue attribute is set to a value that represents the status of its execution.

A Composite-DS-node is a specialized Activity added to UML. It may have a ResultValue attribute to emulate the Result attribute of a Composite-DS for storing the result value after it terminates. In addition, a Composite-DS-node contains multiple Sequence-boxes, multiple DS-nodes emulating parallel sub-DS's in the Composite-DS, a join node, a decision node and multiple ActivityFinalNodes.

This Sequence-box is a specialized Activity added to UML. It is similar to other regular Activities in UML except that when an ActivityFinalNode inside of it executes, not only the Sequence-box but also the containing Composite-DS-node will terminate. Each Sequence-box has an outgoing ActivityEdge leading to a join node.

Transition-arrows leading from a source to multiple targets are emulated in UML by an ActivityEdge leading from the node emulating the source to a decision node, which has one outgoing ActivityEdge emulating each Transition-arrow of the source sub-DS. In addition, the Transition-condition associated with each Transition-arrow is emulated in UML by the guard of the outgoing ActivityEdge that emulates the Transition-arrow.

The FlowFinalNode in UML that emulates an End-point is similar to a regular FlowFinalNode in UML except that when it is reached, the FlowFinalNode that emulates an End-point needs to record the name or its internal ID of the End-point being emulated.

The ActivityFinalNode that emulates an Exit-point in UML is similar to a regular ActivityFinalNode in UML except that when it is reached, it terminates the containing Composite-DS-node, and sets the ResultValue attribute of the Composite-DS-node to the exit-value associated with the Exit-point being emulated.

Each Simple-DS-node or Composite-DS-node emulating a parallel sub-DS in a Composite-DS has one outgoing ActivityEdge leading from it to the join node.

The join node mapped from a Join-fork-node has a default JoinSpec of “and” so that when one token from every node emulating a Sequence or a parallel sub-DS has arrived, the join node completes.

Indirect Exit-points of a Composite-DS may be emulated in UML by an ActivityEdge leading from the join node to a decision node, followed by outgoing ActivityEdges that lead to ActivityFinalNodes. Each indirect Exit-point is emulated by one outgoing ActivityEdge leading from the decision node to an ActivityFinalNode. The Exit-condition of each Exit-point is emulated by the guard of the outgoing ActivityEdge leading to the corresponding ActivityFinalNode.

By taking this emulation approach, the “DS0” Composite-DS 300 in FIG. 3 may be emulated by the “DS0” Composite-DS-node 4100 in an extended version of UML as shown in FIG. 41.

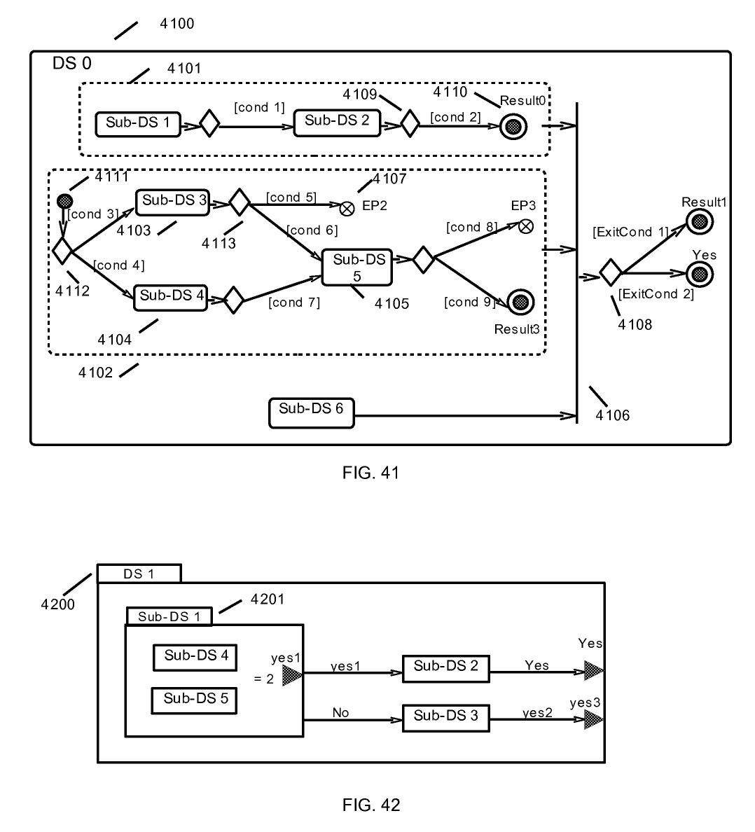

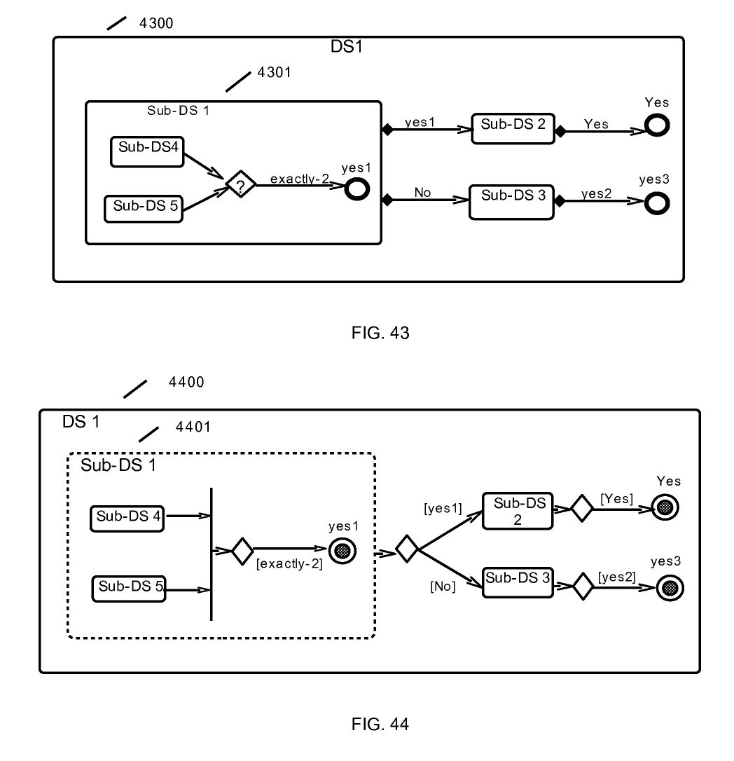

By taking the same approach, a nested Composite-DS may also be emulated by a Composite-DS-node in a graphical language, such as BPMN or UML. For example, FIG. 42 shows a nested Composite-DS, “DS1”. One of its sub-DS's, “Sub-DS1” 4201, contains two sub-DS's, namely “Sub-DS4” and “Sub-DS5”. FIG. 43 shows how the “DS1” 4200 in FIG. 42 may be emulated by the “DS1” Composite-DS-activity 4300 in an extended version of BPMN or a similar graphical language. FIG. 44 shows how the “DS1” 4200 in FIG. 42 may be emulated by the “DS1” Composite-DS-node 4400 in an extended version of UML.

### CONCLUSIONS

The graphical languages described in this invention is versatile and modular. They encourage well structured and modular design of a complex behavior. Therefore, the present invention can be used to benefit various phases of the life cycle of a computing system. In one embodiment of this invention, the graphical languages and extensions described above may be used in a design tool, which is used by a human user to display and edit the behavior specification of a computing system. In another embodiment of this invention, the graphical languages and extensions described above may be used in a monitor tool, which is used by a human user to monitor the run time operation of a computing system being monitored. In yet another embodiment, the graphical languages and extensions described above may be used by a computing system itself to show its run time execution on a graphical display device.

Inside of these tools, DS's and Predicates described above may be implemented in one of many possible internal representations. One internal representation is in the form of data structures of a programming language, such as C or Java. Another internal representation is in the form of a data description language, such as XML. As long as components of a DS or a Predicate are represented internally in a form that can be read by a computer program, such as a Java program, the power and benefits of this invention can be gained even without displaying the behavior in these graphical languages.

Similarly, another embodiment of this invention may embed part of DS and Predicate constructs described in this invention directly in the computer program code. For example, to associate an exit-value to a particular Exit-point, a computer program may hard code a zero value for each implicit Exit-point without having the value stored in a data structure.

On the other hand, not all DS's and Predicates need to be automated or executed by software or hardware. One embodiment may use these constructs to define human activities, business process, or action plans in terms of DS and Predicate components. Some of these DS and Predicate components may be implemented in software or hardware, while some may be implemented as jobs for human to perform.

Although the description above contains many specificities, these should not be construed as limiting the scope of the present invention but as merely providing illustrations of some of the presently described embodiments of the present invention. Based on the disclosure and teachings provided herein, it will be appreciated by a person of ordinary skill in the art that various other embodiments and ramifications are possible within the scope of the present invention.

For example, the exit-value associated with an Exit-point or End-point may be implemented in one of many forms, such as an unsigned integer, an integer, or a character string. In one embodiment of this invention, zero or some negative numbers may be used to represent a non-positive result, while positive numbers may be used to represent positive results. In another embodiment of this invention, a number above or equal to a threshold number may be used to represent a positive result value, while a number below the threshold number may be used to represent a non-positive result value. In yet another embodiment of this invention, a non-zero number may be used to represent a positive result value, whereas zero may be used to represent a non-positive result value. Another embodiment may choose to represent a non-positive result using a string, such as “No” or “false”, while representing positive result values by different strings other than the one used for a non-positive result. It is also possible to combine the exit-value and name of an Exit-point in one embodiment of this invention. For example, a specific name, such as “No”, many be used to represent a non-positive result, while any other user defined name may be used to represent a positive result.

While in one embodiment of the present invention, the exit-value or end-value associated with a particular Exit-point or End-point can be assigned automatically by an editing tool for convenience, in another embodiment, these values may be specified by a designer for maximum flexibility. In yet another embodiment, it is possible that the name string itself of the Exit-point may be used as the exit-value of the Exit-point or vice versa.

When a Sequence reaches an End-point, one embodiment may record the name of the End-point just reached so that it can be examined later by Exit-conditions. However, another embodiment may accomplish the same purpose more efficiently by recording a unique internal identifier that corresponds to each End-point.

Some names used in this invention may be replaced by other names. For example, instead of using “No” for the implicit Exit-point, “False” or “negative” can be used.

Many components described in this invention have a visual representation. Although one particular visual form is used in the description, other visual forms may be used instead. For example, instead of showing an Exit-gateway as a diamond with a question mark inside, it may be shown in another form, such as a hexagon. Another example is that in the current invention, the name and condition of an Exit-point are shown in two separate texts near the Exit-point. One embodiment of this invention may show them together in one text, such as “name: condition”.

Although many components have been described in the present invention, not all of them are required for all applications. For example, there is no parallel sub-predicates in the “D1” Composite-predicate 2000 in FIG. 20. For another example, the “D2” Composite-predicate 2800 example in FIG. 28 does not have any Sequence nor Exit-point.

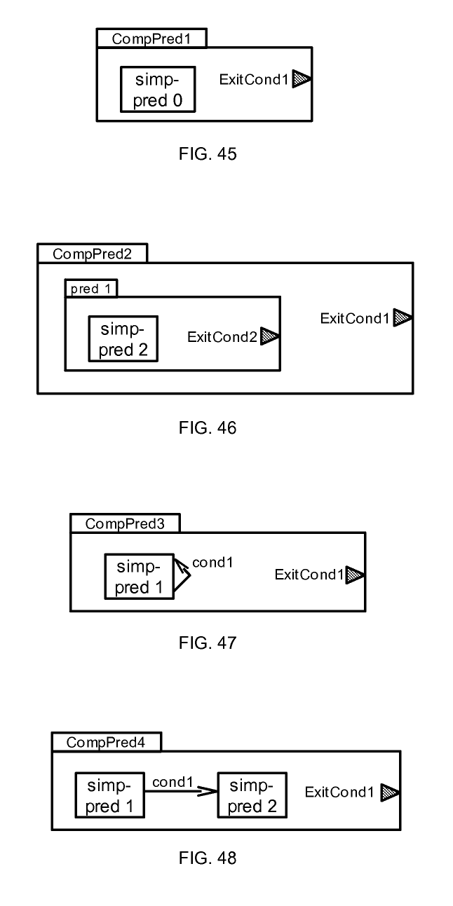

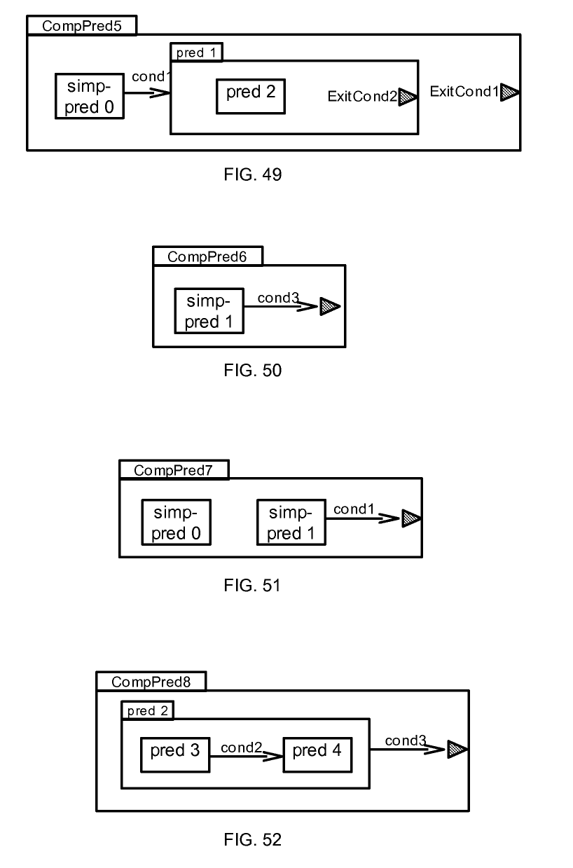

To further clarify this point, more examples are provided here. FIG. 45 shows one example of a Composite-predicate with a subordinate Simple-predicate, “simp-pred0”, and an indirect Exit-point, “ExitCond1”. FIG. 46 shows one example of a Composite-predicate with a subordinate Composite-predicate, “pred1”, and an indirect Exit-point, ExitCond1”. FIG. 47 shows one example of a Composite-predicate with a subordinate Simple-predicate, a Transition, and an indirect Exit-point, “ExitCond1”. FIG. 48 shows one example of a Composite-predicate with two subordinate Simple-predicates, “simp-pred1” and “simp-pred2”, and an indirect Exit-point, “ExitCond1”. FIG. 49 shows one example of a Composite-predicate with a subordinate Simple-predicate, “simp-pred0”, a subordinate Composite-predicate, “pred1”, and an indirect Exit-point, “ExitCond1”. FIG. 50 shows one example of a Composite-predicate with a subordinate Simple-predicate, “simp-pred1”, a Transition, and a direct Exit-point. FIG. 51 shows one example of a Composite-predicate with two subordinate Simple-predicates, “simp-pred0” and “simp-pred1”, a Transition, and a direct Exit-point. FIG. 52 shows one example of a Composite-predicate with a subordinate Composite-predicate, “pred2”, a Transition, and a direct Exit-point.

Any of the software components or functions described in this application, may be implemented as program code to be executed by one or more processors using any suitable computer language such as, for example, Java, C++ or Perl using, for example, conventional or object-oriented techniques. The program code may be stored as a series of instructions, or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such program code may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such program code. Computer readable media encoded with the program code may be packaged with a compatible device or provided separately from other devices (e.g., via Internet download). Any such computer readable medium may reside on or within a single computer program product (e.g. a hard drive or an entire computer system), and may be present on or within different computer program products within a system or network. A computer system may include a monitor, printer, or other suitable display for providing any of the results mentioned herein to a user. When the program code is loaded into and executed by a physical computing device or machine, the machine becomes an apparatus for practicing the invention.

Accordingly, it can be seen that components of a DS and a Predicate, and their related GUI representations and procedures described in accordance with the present invention is a very powerful technique to define complex behavior of many computing systems. In particular, the present invention extends and improves the prior art, BPMN, XPDL, WS-CDL or UML, in several major areas.

One is that even complex decisions may be presented graphically as Composite-predicates. As a result, more behavior can be presented in graphics instead of in code or data, which can be very difficult to design and maintain. The second is that both sequential sub-predicates and parallel sub-predicates are directly supported in a Composite-predicate. This flexibility allows a wide range of complex decision behaviors be specified in a clean and modular fashion. The third is that multiple positive result values are supported so that multiple boolean decisions may be combined into one single Composite-predicate for better performance. The forth is that the behaviors of implicit Exit-point and implicit End-point are automatically provided so that a design may be drastically simplified. The fifth is that by providing a particular powerful and yet flexible compositional structure, a lot of design complexity can be eliminated. For example, the emulation of Composite-DS's and Composite-predicates in BPMN uses only one Exit-gateway while eliminating all four existing Gateway types and their numerous combinations in BPMN.

The above description of exemplary embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated. All publications, patents, and patent applications cited herein are hereby incorporated by reference for all purposes in their entirety.

What is claimed is:

1. A computer system comprising instructions to direct at least one processor to evaluate at least one composite-predicate for checking whether at least one complex condition is met or not and evaluating to either a positive value or a non-positive value respectively, wherein each said composite-predicate comprising:
at least one indirect-exit-point, a result, and at least one sequence, wherein:
a) each said indirect-exit-point comprises an exit-value and an exit-condition, wherein:
said exit-value whose value is one of a positive value and a non-positive value; and
said exit-condition specifies a termination situation under which evaluation of said composite-predicate exits;
b) said result is an attribute to store said exit-value when said composite-predicate exits at said indirect-exit-point; and
c) each said sequence is evaluated when said composite-predicate is evaluated, and each said sequence comprising at least one subordinate predicate, wherein each said subordinate predicate comprises one of a lower level composite-predicate and a simple-predicate, wherein said simple-predicate specifies a simple condition to check, and if said simple condition is met, said simple-predicate evaluates to a positive value and if said simple condition is not met, said simple-predicate evaluates to a non-positive value.

2. The computer system of claim 1, wherein at least one of said indirect-exit-point further comprising an Exit-name that specifies a name for identifying said indirect-exit-point.

3. The computer system of claim 1, wherein at least one of said sequence further comprising at least one transition,
wherein each said transition comprises a source, a target, and a transition-condition, wherein:
a) said source specifies a first said subordinate predicate;
b) said target specifies a second said subordinate predicate; and
c) said transition-condition specifies a situation, wherein if said situation is met, said target is evaluated after said source is evaluated.

4. The computer system of claim 3, wherein at least one of said sequence further comprising at least one direct-exit-point as the target of one of said transition, wherein each said direct-exit-point comprises one of said exit-value, when said direct-exit-point is evaluated, said composite-predicate terminates and evaluates to said exit-value associated with said direct-exit-point.

5. The computer system of claim 3, wherein at least one of said sequence further comprising a user defined end-point pointed to by at least one of said transition, wherein when said user defined end-point is evaluated, said at least one of said sequence terminates at said user defined end-point and evaluates to a positive value.

6. The computer system of claim 3, wherein at least one of said sequence further comprising an implicit-end-point, wherein when one of said source has been evaluated and none of said transition-condition of the source is met, said at least one of said sequence terminates at said implicit-end-point and evaluates to a non-positive value.

7. The computer system of claim 1, wherein at least one of said composite-predicate further comprising an implicit-exit-point, wherein when each said sequence has exited without reaching any one of said indirect-exit-point and said direct-exit-point, said at least one of said composite-predicate exits at said implicit-exit-point and evaluates to a non-positive value.

8. The computer system of claim 1, wherein said exit-condition in at least one of said indirect-exit-point specifies how many said sequence should have evaluated to positive value in order for said composite-predicate to exit and evaluate to the exit-value of said at least one of said indirect-exit-point.

9. The computer system of claim 8, wherein said exit-condition in at least one of said indirect-exit-point specifies a logical OR condition stating that when at least one of said sequence has evaluated to a positive value, said composite-predicate exits and evaluates to the exit-value of said at least one of said indirect-exit-point.

10. The computer system of claim 8, wherein said exit-condition in at least one of said indirect-exit-point specifies a logical AND condition stating that when each of said sequence has evaluated to a positive value, said composite-predicate exits and evaluates to the exit-value of said at least one of said indirect-exit-point.

11. A computer system comprising instructions to direct at least one processor to evaluate at least one composite-predicate for checking whether at least one complex condition is met or not and evaluating to either a positive value or a non-positive value respectively, wherein each said composite-predicate comprising: at least one sequence and a result, wherein:
each said sequence is evaluated when said composite-predicate is evaluated, and each said sequence comprises at least one subordinate predicate, at least one transition and at least one direct-exit-point, wherein:
a) each said subordinate predicate comprises one of a low level composite-predicate and a simple-predicate, wherein said simple-predicate specifies a simple condition to check, and if said simple condition is met, said simple-predicate evaluates to a first positive value and if said simple condition is not met, said simple-predicate evaluates to a first non-positive value;
b) each said transition comprises a source, a target, and a transition-condition, wherein:
said source specifies a first subordinate predicate;
said target specifies either a second subordinate predicate or one of said direct-exit-point; and
said transition-condition specifies a situation, wherein if said situation is met, said target is evaluated after said source is evaluated; and
c) each said direct-exit-point comprises an exit-value whose value is either a second positive value or a second non-positive value, and
when said each said direct-exit-point is evaluated, evaluation of said composite-predicate exits and evaluates to the exit-value associated with the direct-exit-point; and
said result is an attribute to store said exit-value associated with the direct-exit-point at which said composite-predicate exits.

12. The computer system of claim 11, wherein at least one of said direct-exit-point further comprising an Exit-name that specifies a name for identifying said direct-exit-point.

13. The computer system of claim 11, wherein at least one of said composite-predicate further comprising at least one indirect-exit-point, wherein each said indirect-exit-point comprises an exit-value, and an exit-condition, wherein:
a) said exit-value whose value is one of a positive value and a non-positive value; and
b) said exit-condition specifies a termination situation under which evaluation of said composite-predicate exits and evaluates to said exit-value.

14. A computer system comprising a Graphical User Interface (GUI) for displaying on a display device at least one composite-predicate-item that visually represents a composite-predicate for checking whether at least one complex condition is met or not and evaluating to either a first positive value or a first non-positive value respectively,
wherein each said composite-predicate-item comprising:
at least one indirect-exit-point-item and at least one sequence-item, wherein:
a) each said indirect-exit-point-item comprises an exit-point-item, an exit-condition-item and an exit-value, wherein:
said exit-point-item visually represents a point where said composite-predicate is capable of exiting, and
said exit-condition-item visually represents a termination situation under which evaluation of said composite-predicate-item exits and evaluates to said exit-value associated with said indirect-exit-point-item; and
b) each said sequence-item is evaluated when said composite-predicate-item is evaluated, and each said sequence-item comprises at least one subordinate predicate-item, wherein each said subordinate predicate-item visually represents one of a lower level composite-predicate and a simple-predicate, wherein said simple-predicate specifies a simple condition to check, and if said simple condition is met, said simple-predicate evaluates to a second positive value and if said simple condition is not met, said simple-predicate-item evaluates to a second non-positive value.

15. The computer system of claim 14, wherein at least one of said indirect-exit-point-item further comprising an Exit-name that visually specifies a name for identifying said indirect-exit-point-item.

16. The computer system of claim 14, wherein at least one of a group consisting of said composite-predicate-item, said indirect-exit-point-item, said sequence-item, and said simple-predicate-item is visually represented by an exiting graphical element of a graphical language.

17. The computer system of claim 14, wherein at least one of said sequence-item further comprising at least one transition-item,
wherein each said transition-item visually connects a source to a target and comprises a transition-condition-item, wherein:
said source specifies a first said subordinate predicate-item;
said target specifies a second said subordinate predicate-item; and
said transition-condition-item visually represents a transition-condition that specifies a situation, wherein if said situation is met, said target is evaluated after said source is evaluated.

18. The computer system of claim 17, wherein at least one of said transition-item is visually represented by an exiting graphical element of a graphical language.

19. The computer system of claim 17, wherein at least one of said sequence-item further comprising at least one direct-exit-point-item as the target of one of said transition-item, wherein when said direct-exit-point is evaluated, said composite-predicate exits and evaluates to either a positive value or a non-positive value.

20. The computer system of claim 19, wherein at least one of said direct-exit-point-item is visually represented by an exiting graphical element of a graphical language.

21. The computer system of claim 17, wherein at least one of said sequence-item further comprising a user defined end-point-item pointed to by at least one of said transition-item, wherein when said user defined end-point-item is evaluated, said at least one of said sequence-item terminates and evaluates to a positive value.

22. The computer system of claim 21, wherein said user defined end-point-item is visually represented by an exiting graphical element of a graphical language.

23. A computer system comprising a Graphical User Interface (GUI) for displaying on a display device at least one composite-predicate-item that visually represents a composite-predicate for checking whether at least one complex condition is met or not and evaluating to either a first positive value or a first non-positive value respectively,
wherein each said composite-predicate-item comprising at least one sequence-item, wherein each said sequence-item is evaluated when said composite-predicate-item is evaluated, and each said sequence-item comprises at least one subordinate predicate-item, at least one transition-item, and at least one direct-exit-point-item, wherein:
a) each said subordinate predicate-item comprises one of a lower level composite-predicate-item and a simple-predicate-item, wherein said simple-predicate-item visually represents a simple condition to check, and if said simple condition is met, said simple-predicate-item evaluates to a second positive value and if said simple condition is not met, said simple-predicate-item evaluates to a second non-positive value;
b) each said transition-item visually connects a source to a target and comprises a transition-condition-item, wherein:
said source specifies a first subordinate predicate-item;
said target specifies either one of said subordinate predicate-item or one of said direct-exit-point-item; and
said transition-condition-item visually represents a situation, wherein if said situation is met, said target is evaluated after said source is evaluated; and
c) each said direct-exit-point-item is connected by one of said transition-item as the target, wherein when said direct-exit-point-item is evaluated, said composite-predicate-item exits and evaluates to one of said first positive value and said first non-positive value.

24. The computer system of claim 23, wherein at least one of said direct-exit-point-item further comprising an Exit-name that visually specifies a name for identifying said direct-exit-point-item.

25. The computer system of claim 23, wherein at least one of a group consisting of said composite-predicate-item, said sequence-item, said simple-predicate-item, said direct-exit-point-item, and said transition-item is visually represented by an exiting graphical element of a graphical language.

26. The computer system of claim 23, wherein at least one of said composite-predicate-item further comprising at least one indirect-exit-point-item, wherein each said indirect-exit-point-item comprises an exit-point-item, and an exit-condition-item, wherein:
said exit-point-item visually represents a point where said at least one composite-predicate is capable of exiting, and
said exit-condition-item visually represents a termination situation under which evaluation of said composite-predicate-item exits and evaluates to one of a positive value and a non-positive value.

27. The computer system of claim 26, wherein at least one of said indirect-exit-point-item is visually represented by an exiting graphical element of a graphical language.
